(19) United States
(12) Patent Application Publication
(10) Pub. No.: US 2026/0052531 A1
(43) Pub. Date: Feb. 19, 2026

(54) USE DEFAULT PTRS PATTERN AND DENSITY IN RETRANSMISSION

(71) Applicant: QUALCOMM Incorporated, San Diego, CA (US)

(72) Inventors: Yi HUANG, San Diego, CA (US); Gabi SARKIS, San Diego, CA (US)

(21) Appl. No.: 18/809,068

(22) Filed: Aug. 19, 2024

(51) Int. Cl. H04W 72/1273; H04L 1/00; H04L 5/00; H04W 72/1268; H04W 72/231

(52) U.S. Cl. CPC H04W 72/1273; H04L 1/0003; H04L 5/0051; H04W 72/1268; H04W 72/231

(57) ABSTRACT

A method for wireless communication at a user equipment (UE) and related apparatus are provided. In the method, the UE transmits or receives a first transmission of a physical channel. The physical channel includes one of a physical downlink shared channel (PDSCH) or a physical uplink shared channel (PUSCH). The UE further transmits or receives a subsequent retransmission of the physical channel. The subsequent retransmission of the physical channel includes a phase tracking reference signal (PTRS) having a pattern, and the pattern is independent of whether the first transmission was an initial transmission or a prior retransmission.

### TECHNICAL FIELD

The present disclosure relates generally to communication systems and, more particularly, to the use of a default phase tracking reference signal (PTRS) pattern and density in data retransmissions.

### INTRODUCTION

Wireless communication systems are widely deployed to provide various telecommunication services such as telephony, video, data, messaging, and broadcasts. Typical wireless communication systems may employ multiple-access technologies capable of supporting communication with multiple users by sharing available system resources. Examples of such multiple-access technologies include code division multiple access (CDMA) systems, time division multiple access (TDMA) systems, frequency division multiple access (FDMA) systems, orthogonal frequency division multiple access (OFDMA) systems, single-carrier frequency division multiple access (SC-FDMA) systems, and time division synchronous code division multiple access (TD-SCDMA) systems.

These multiple access technologies have been adopted in various telecommunication standards to provide a common protocol that enables different wireless devices to communicate on a municipal, national, regional, and even global level. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IOT)), and other requirements. 5G NR includes services associated with enhanced mobile broadband (eMBB), massive machine type communications (mMTC), and ultra-reliable low latency communications (URLLC). Some aspects of 5G NR may be based on the 4G Long Term Evolution (LTE) standard. There exists a need for further improvements in 5G NR technology. These improvements may also be applicable to other multi-access technologies and the telecommunication standards that employ these technologies.

### BRIEF SUMMARY

The following presents a simplified summary of one or more aspects in order to provide a basic understanding of such aspects. This summary is not an extensive overview of all contemplated aspects. This summary neither identifies key or critical elements of all aspects nor delineates the scope of any or all aspects. Its sole purpose is to present some concepts of one or more aspects in a simplified form as a prelude to the more detailed description that is presented later.

In an aspect of the disclosure, a method, a computer-readable medium, and an apparatus are provided for wireless communication at a user equipment (UE). The apparatus may include at least one memory and at least one processor coupled to the at least one memory. Based at least in part on information stored in the at least one memory, the at least one processor, individually or in any combination, may be configured to transmit or receive a first transmission of a physical channel, where the physical channel includes one of a physical downlink shared channel (PDSCH) or a physical uplink shared channel (PUSCH); and transmit or receive a subsequent retransmission of the physical channel, where the subsequent retransmission of the physical channel includes a phase tracking reference signal (PTRS) having a pattern that is independent of whether the first transmission was an initial transmission or a prior retransmission.

In an aspect of the disclosure, a method, a computer-readable medium, and an apparatus are provided for wireless communication at a network entity. The apparatus may include at least one memory and at least one processor coupled to the at least one memory. Based at least in part on information stored in the at least one memory, the at least one processor, individually or in any combination, may be configured to transmit or receive a first transmission of a physical channel, where the physical channel includes one of a PDSCH or a PUSCH, where the first transmission of the physical channel includes a PTRS having a pattern; and transmit or receive a subsequent retransmission of the physical channel, where the subsequent retransmission of the physical channel includes a PTRS having the pattern, where the pattern is independent of whether the first transmission was an initial transmission or a prior retransmission.

To the accomplishment of the foregoing and related ends, the one or more aspects may include the features hereinafter fully described and particularly pointed out in the claims. The following description and the drawings set forth in detail certain illustrative features of the one or more aspects. These features are indicative, however, of but a few of the various ways in which the principles of various aspects may be employed.

### BRIEF DESCRIPTION OF THE DRAWINGS

FIG. 1 is a diagram illustrating an example of a wireless communication system and an access network.

FIG. 2A is a diagram illustrating an example of a first frame, in accordance with various aspects of the present disclosure.

FIG. 2B is a diagram illustrating an example of downlink (DL) channels within a subframe, in accordance with various aspects of the present disclosure.

FIG. 2C is a diagram illustrating an example of a second frame, in accordance with various aspects of the present disclosure.

FIG. 2D is a diagram illustrating an example of uplink (UL) channels within a subframe, in accordance with various aspects of the present disclosure.

FIG. 3 is a diagram illustrating an example of a base station and user equipment (UE) in an access network.

FIG. 4 is a diagram illustrating an example of a phase tracking reference signal (PTRS) in data transmission.

FIG. 5 is a diagram illustrating an example of a retransmission of a physical downlink shared channel (PDSCH) or a physical uplink shared channel (PUSCH).

FIG. 6 is a diagram illustrating an example of different MCS used by the base station and the UE due to missed downlink control information (DCI).

FIG. 7 is a call flow diagram illustrating a method of wireless communication in accordance with various aspects of the present disclosure.

FIG. 8 is a flowchart illustrating methods of wireless communication at a UE in accordance with various aspects of the present disclosure.

FIG. 9 is a flowchart illustrating methods of wireless communication at a network entity in accordance with various aspects of the present disclosure.

FIG. 10 is a diagram illustrating an example of a hardware implementation for an example apparatus and/or UE.

FIG. 11 is a diagram illustrating an example of a hardware implementation for an example network entity.

### DETAILED DESCRIPTION

In wireless communication, signals transmitted via the physical downlink shared channel (PDSCH) or physical uplink shared channel (PUSCH) may be retransmitted if the initial transmission fails, e.g., when the initial transmission is not successfully decoded by the receiver. A retransmission of PDSCH or PUSCH may include a phase tracking reference signal (PTRS), where the pattern or density of the PTRS is determined by the modulation and coding scheme (MCS) of the initial transmission or a prior retransmission depending on the MCS value. However, when the UE misses a downlink control information (DCI) message, this lack of information may cause discrepancies between the base station and the UE regarding the details of the initial transmission. As a result, the base station and UE may employ different MCS when determining the PTRS pattern and density for subsequent retransmissions. Such discrepancies may adversely affect the effectiveness of the communication. Example aspects presented herein provide methods and apparatus to enable the use of a fixed PTRS pattern and density to ensure the consistency of the PTRS settings during retransmissions.

Various aspects relate generally to wireless communication. Some aspects more specifically relate to the use of a fixed PTRS pattern and density in data retransmissions. In some examples, a user equipment (UE) transmits or receives a first transmission of a physical channel. The physical channel may include one of a PDSCH or a PUSCH. The UE may further transmit or receive a subsequent retransmission of the physical channel, and the subsequent retransmission of the physical channel may include a PTRS having a pattern. In some examples, the pattern of the PTRS may be based on a configured pattern or a pattern configuration received from a network entity. In some examples, the pattern of the PTRS may be determined based on a modulation and coding scheme (MCS). In some examples, the subsequent retransmission of the physical channel may include multiple codewords, and the pattern of the PTRS may be based on a fixed codeword of the multiple codewords.

Particular aspects of the subject matter described in this disclosure can be implemented to realize one or more of the following potential advantages. In some examples, by using a fixed PTRS setting, which may be determined based on a fixed MCS or a fixed codeword, for the subsequent retransmissions of signals on the PDSCH or PUSCH, the described techniques address and mitigate the discrepancies and inconsistencies resulting from missed DCI about initial transmission statuses, thereby enhancing the reliability and efficiency of wireless communication. In some examples, by consistently using a fixed MCS or a fixed codeword for PTRS in retransmissions, the described techniques simplify the decision-making process for PTRS settings in retransmissions, thereby lowering the computational burden on the network or UE.

The detailed description set forth below in connection with the drawings describes various configurations and does not represent the only configurations in which the concepts described herein may be practiced. The detailed description includes specific details for the purpose of providing a thorough understanding of various concepts. However, these concepts may be practiced without these specific details. In some instances, well known structures and components are shown in block diagram form in order to avoid obscuring such concepts.

Several aspects of telecommunication systems are presented with reference to various apparatus and methods. These apparatus and methods are described in the following detailed description and illustrated in the accompanying drawings by various blocks, components, circuits, processes, algorithms, etc. (collectively referred to as “elements”). These elements may be implemented using electronic hardware, computer software, or any combination thereof. Whether such elements are implemented as hardware or software depends upon the particular application and design constraints imposed on the overall system.

By way of example, an element, or any portion of an element, or any combination of elements may be implemented as a “processing system” that includes one or more processors. When multiple processors are implemented, the multiple processors may perform the functions individually or in combination. Examples of processors include microprocessors, microcontrollers, graphics processing units (GPUs), central processing units (CPUs), application processors, digital signal processors (DSPs), reduced instruction set computing (RISC) processors, systems on a chip (SoC), baseband processors, field programmable gate arrays (FPGAs), programmable logic devices (PLDs), state machines, gated logic, discrete hardware circuits, and other suitable hardware configured to perform the various functionality described throughout this disclosure. One or more processors in the processing system may execute software. Software, whether referred to as software, firmware, middleware, microcode, hardware description language, or otherwise, shall be construed broadly to mean instructions, instruction sets, code, code segments, program code, programs, subprograms, software components, applications, software applications, software packages, routines, subroutines, objects, executables, threads of execution, procedures, functions, or any combination thereof.

Accordingly, in one or more example aspects, implementations, and/or use cases, the functions described may be implemented in hardware, software, or any combination thereof. If implemented in software, the functions may be stored on or encoded as one or more instructions or code on a computer-readable medium. Computer-readable media includes computer storage media. Storage media may be any available media that can be accessed by a computer. By way of example, such computer-readable media can include a random-access memory (RAM), a read-only memory (ROM), an electrically erasable programmable ROM (EEPROM), optical disk storage, magnetic disk storage, other magnetic storage devices, combinations of the types of computer-readable media, or any other medium that can be used to store computer executable code in the form of instructions or data structures that can be accessed by a computer.

While aspects, implementations, and/or use cases are described in this application by illustration to some examples, additional or different aspects, implementations and/or use cases may come about in many different arrangements and scenarios. Aspects, implementations, and/or use cases described herein may be implemented across many differing platform types, devices, systems, shapes, sizes, and packaging arrangements. For example, aspects, implementations, and/or use cases may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described examples may occur. Aspects, implementations, and/or use cases may range a spectrum from chip-level or modular components to non-modular, non-chip-level implementations and further to aggregate, distributed, or original equipment manufacturer (OEM) devices or systems incorporating one or more techniques herein. In some practical settings, devices incorporating described aspects and features may also include additional components and features for implementation and practice of claimed and described aspect. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). Techniques described herein may be practiced in a wide variety of devices, chip-level components, systems, distributed arrangements, aggregated or disaggregated components, end-user devices, etc. of varying sizes, shapes, and constitution.

Deployment of communication systems, such as 5G NR systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB, access point (AP), a transmission reception point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU can be implemented as virtual units, i.e., a virtual central unit (VCU), a virtual distributed unit (VDU), or a virtual radio unit (VRU).

Base station operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

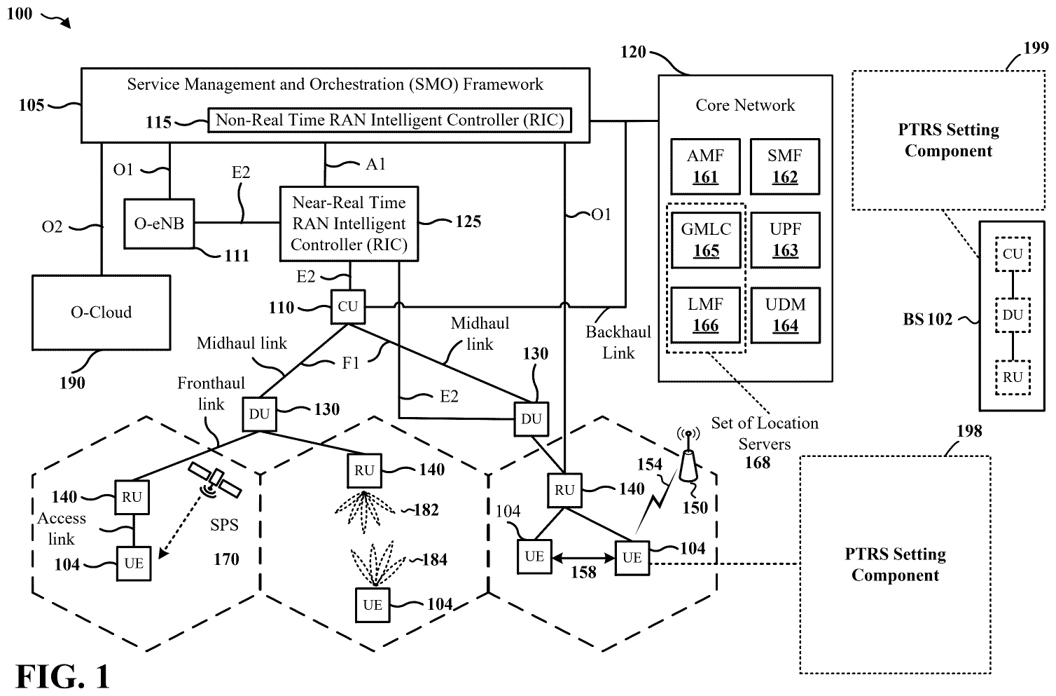

FIG. 1 is a diagram 100 illustrating an example of a wireless communications system and an access network. The illustrated wireless communications system includes a disaggregated base station architecture. The disaggregated base station architecture may include one or more CUs 110 that can communicate directly with a core network 120 via a backhaul link, or indirectly with the core network 120 through one or more disaggregated base station units (such as a Near-Real Time (Near-RT) RAN Intelligent Controller (RIC) 125 via an E2 link, or a Non-Real Time (Non-RT) RIC 115 associated with a Service Management and Orchestration (SMO) Framework 105, or both). A CU 110 may communicate with one or more DUs 130 via respective midhaul links, such as an F1 interface. The DUs 130 may communicate with one or more RUs 140 via respective fronthaul links. The RUs 140 may communicate with respective UEs 104 via one or more radio frequency (RF) access links. In some implementations, the UE 104 may be simultaneously served by multiple RUs 140.

Each of the units, i.e., the CUS 110, the DUs 130, the RUs 140, as well as the Near-RT RICs 125, the Non-RT RICs 115, and the SMO Framework 105, may include one or more interfaces or be coupled to one or more interfaces configured to receive or to transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or to transmit signals over a wired transmission medium to one or more of the other units. Additionally, the units can include a wireless interface, which may include a receiver, a transmitter, or a transceiver (such as an RF transceiver), configured to receive or to transmit signals, or both, over a wireless transmission medium to one or more of the other units.

In some aspects, the CU 110 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 110. The CU 110 may be configured to handle user plane functionality (i.e., Central Unit-User Plane (CU-UP)), control plane functionality (i.e., Central Unit-Control Plane (CU-CP)), or a combination thereof. In some implementations, the CU 110 can be logically split into one or more CU-UP units and one or more CU-CP units. The CU-UP unit can communicate bidirectionally with the CU-CP unit via an interface, such as an E1 interface when implemented in an O-RAN configuration. The CU 110 can be implemented to communicate with the DU 130, as necessary, for network control and signaling.

The DU 130 may correspond to a logical unit that includes one or more base station functions to control the operation of one or more RUs 140. In some aspects, the DU 130 may host one or more of a radio link control (RLC) layer, a medium access control (MAC) layer, and one or more high physical (PHY) layers (such as modules for forward error correction (FEC) encoding and decoding, scrambling, modulation, demodulation, or the like) depending, at least in part, on a functional split, such as those defined by 3GPP. In some aspects, the DU 130 may further host one or more low PHY layers. Each layer (or module) can be implemented with an interface configured to communicate signals with other layers (and modules) hosted by the DU 130, or with the control functions hosted by the CU 110.

Lower-layer functionality can be implemented by one or more RUs 140. In some deployments, an RU 140, controlled by a DU 130, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 140 can be implemented to handle over the air (OTA) communication with one or more UEs 104. In some implementations, real-time and non-real-time aspects of control and user plane communication with the RU(s) 140 can be controlled by the corresponding DU 130. In some scenarios, this configuration can enable the DU(s) 130 and the CU 110 to be implemented in a cloud-based RAN architecture, such as a vRAN architecture.

The SMO Framework 105 may be configured to support RAN deployment and provisioning of non-virtualized and virtualized network elements. For non-virtualized network elements, the SMO Framework 105 may be configured to support the deployment of dedicated physical resources for RAN coverage requirements that may be managed via an operations and maintenance interface (such as an O1 interface). For virtualized network elements, the SMO Framework 105 may be configured to interact with a cloud computing platform (such as an open cloud (O-Cloud) 190) to perform network element life cycle management (such as to instantiate virtualized network elements) via a cloud computing platform interface (such as an O2 interface). Such virtualized network elements can include, but are not limited to, CUs 110, DUs 130, RUs 140 and Near-RT RICs 125. In some implementations, the SMO Framework 105 can communicate with a hardware aspect of a 4G RAN, such as an open eNB (O-eNB) 111, via an O1 interface. Additionally, in some implementations, the SMO Framework 105 can communicate directly with one or more RUs 140 via an O1 interface. The SMO Framework 105 also may include a Non-RT RIC 115 configured to support functionality of the SMO Framework 105.

The Non-RT RIC 115 may be configured to include a logical function that enables non-real-time control and optimization of RAN elements and resources, artificial intelligence (AI)/machine learning (ML) (AI/ML) workflows including model training and updates, or policy-based guidance of applications/features in the Near-RT RIC 125. The Non-RT RIC 115 may be coupled to or communicate with (such as via an A1 interface) the Near-RT RIC 125. The Near-RT RIC 125 may be configured to include a logical function that enables near-real-time control and optimization of RAN elements and resources via data collection and actions over an interface (such as via an E2 interface) connecting one or more CUs 110, one or more DUs 130, or both, as well as an O-eNB, with the Near-RT RIC 125.

In some implementations, to generate AI/ML models to be deployed in the Near-RT RIC 125, the Non-RT RIC 115 may receive parameters or external enrichment information from external servers. Such information may be utilized by the Near-RT RIC 125 and may be received at the SMO Framework 105 or the Non-RT RIC 115 from non-network data sources or from network functions. In some examples, the Non-RT RIC 115 or the Near-RT RIC 125 may be configured to tune RAN behavior or performance. For example, the Non-RT RIC 115 may monitor long-term trends and patterns for performance and employ AI/ML models to perform corrective actions through the SMO Framework 105 (such as reconfiguration via O1) or via creation of RAN management policies (such as A1 policies).

At least one of the CU 110, the DU 130, and the RU 140 may be referred to as a base station 102. Accordingly, a base station 102 may include one or more of the CU 110, the DU 130, and the RU 140 (each component indicated with dotted lines to signify that each component may or may not be included in the base station 102). The base station 102 provides an access point to the core network 120 for a UE 104. The base station 102 may include macrocells (high power cellular base station) and/or small cells (low power cellular base station). The small cells include femtocells, picocells, and microcells. A network that includes both small cell and macrocells may be known as a heterogeneous network. A heterogeneous network may also include Home Evolved Node Bs (eNBs) (HeNBs), which may provide service to a restricted group known as a closed subscriber group (CSG). The communication links between the RUs 140 and the UEs 104 may include uplink (UL) (also referred to as reverse link) transmissions from a UE 104 to an RU 140 and/or downlink (DL) (also referred to as forward link) transmissions from an RU 140 to a UE 104. The communication links may use multiple-input and multiple-output (MIMO) antenna technology, including spatial multiplexing, beamforming, and/or transmit diversity. The communication links may be through one or more carriers. The base station 102/UEs 104 may use spectrum up to Y MHz (e.g., 5, 10, 15, 20, 100, 400, etc. MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Certain UEs 104 may communicate with each other using device-to-device (D2D) communication link 158. The D2D communication link 158 may use the DL/UL wireless wide area network (WWAN) spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, Bluetooth™ (Bluetooth is a trademark of the Bluetooth Special Interest Group (SIG)), Wi-Fi™ (Wi-Fi is a trademark of the Wi-Fi Alliance) based on the Institute of Electrical and Electronics Engineers (IEEE) 802.11 standard, LTE, or NR.

The wireless communications system may further include a Wi-Fi AP 150 in communication with UEs 104 (also referred to as Wi-Fi stations (STAs)) via communication link 154, e.g., in a 5 GHz unlicensed frequency spectrum or the like. When communicating in an unlicensed frequency spectrum, the UEs 104/AP 150 may perform a clear channel assessment (CCA) prior to communicating in order to determine whether the channel is available.

The electromagnetic spectrum is often subdivided, based on frequency/wavelength, into various classes, bands, channels, etc. In 5G NR, two initial operating bands have been identified as frequency range designations FR1 (410 MHZ-7.125 GHZ) and FR2 (24.25 GHz-52.6 GHz). Although a portion of FR1 is greater than 6 GHz, FR1 is often referred to (interchangeably) as a “sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHZ-24.25 GHZ). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR2-2 (52.6 GHZ-71 GHZ), FR4 (71 GHz-114.25 GHZ), and FR5 (114.25 GHz-300 GHz). Each of these higher frequency bands falls within the EHF band.

With the above aspects in mind, unless specifically stated otherwise, the term “sub-6 GHz” or the like if used herein may broadly represent frequencies that may be less than 6 GHz, may be within FR1, or may include mid-band frequencies. Further, unless specifically stated otherwise, the term “millimeter wave” or the like if used herein may broadly represent frequencies that may include mid-band frequencies, may be within FR2, FR4, FR2-2, and/or FR5, or may be within the EHF band.

The base station 102 and the UE 104 may each include a plurality of antennas, such as antenna elements, antenna panels, and/or antenna arrays to facilitate beamforming. The base station 102 may transmit a beamformed signal 182 to the UE 104 in one or more transmit directions. The UE 104 may receive the beamformed signal from the base station 102 in one or more receive directions. The UE 104 may also transmit a beamformed signal 184 to the base station 102 in one or more transmit directions. The base station 102 may receive the beamformed signal from the UE 104 in one or more receive directions. The base station 102/UE 104 may perform beam training to determine the best receive and transmit directions for each of the base station 102/UE 104. The transmit and receive directions for the base station 102 may or may not be the same. The transmit and receive directions for the UE 104 may or may not be the same.

The base station 102 may include and/or be referred to as a gNB, Node B, eNB, an access point, a base transceiver station, a radio base station, a radio transceiver, a transceiver function, a basic service set (BSS), an extended service set (ESS), a TRP, network node, network entity, network equipment, or some other suitable terminology. The base station 102 can be implemented as an integrated access and backhaul (IAB) node, a relay node, a sidelink node, an aggregated (monolithic) base station with a baseband unit (BBU) (including a CU and a DU) and an RU, or as a disaggregated base station including one or more of a CU, a DU, and/or an RU. The set of base stations, which may include disaggregated base stations and/or aggregated base stations, may be referred to as next generation (NG) RAN (NG-RAN).

The core network 120 may include an Access and Mobility Management Function (AMF) 161, a Session Management Function (SMF) 162, a User Plane Function (UPF) 163, a Unified Data Management (UDM) 164, one or more location servers 168, and other functional entities. The AMF 161 is the control node that processes the signaling between the UEs 104 and the core network 120. The AMF 161 supports registration management, connection management, mobility management, and other functions. The SMF 162 supports session management and other functions. The UPF 163 supports packet routing, packet forwarding, and other functions. The UDM 164 supports the generation of authentication and key agreement (AKA) credentials, user identification handling, access authorization, and subscription management. The one or more location servers 168 are illustrated as including a Gateway Mobile Location Center (GMLC) 165 and a Location Management Function (LMF) 166. However, generally, the one or more location servers 168 may include one or more location/positioning servers, which may include one or more of the GMLC 165, the LMF 166, a position determination entity (PDE), a serving mobile location center (SMLC), a mobile positioning center (MPC), or the like. The GMLC 165 and the LMF 166 support UE location services. The GMLC 165 provides an interface for clients/applications (e.g., emergency services) for accessing UE positioning information. The LMF 166 receives measurements and assistance information from the NG-RAN and the UE 104 via the AMF 161 to compute the position of the UE 104. The NG-RAN may utilize one or more positioning methods in order to determine the position of the UE 104. Positioning the UE 104 may involve signal measurements, a position estimate, and an optional velocity computation based on the measurements. The signal measurements may be made by the UE 104 and/or the base station 102 serving the UE 104. The signals measured may be based on one or more of a satellite positioning system (SPS) 170 (e.g., one or more of a Global Navigation Satellite System (GNSS), global position system (GPS), non-terrestrial network (NTN), or other satellite position/location system), LTE signals, wireless local area network (WLAN) signals, Bluetooth signals, a terrestrial beacon system (TBS), sensor-based information (e.g., barometric pressure sensor, motion sensor), NR enhanced cell ID (NR E-CID) methods, NR signals (e.g., multi-round trip time (Multi-RTT), DL angle-of-departure (DL-AoD), DL time difference of arrival (DL-TDOA), UL time difference of arrival (UL-TDOA), and UL angle-of-arrival (UL-AoA) positioning), and/or other systems/signals/sensors.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player (e.g., MP3 player), a camera, a game console, a tablet, a smart device, a wearable device, a vehicle, an electric meter, a gas pump, a large or small kitchen appliance, a healthcare device, an implant, a sensor/actuator, a display, or any other similar functioning device. Some of the UEs 104 may be referred to as IoT devices (e.g., parking meter, gas pump, toaster, vehicles, heart monitor, etc.). The UE 104 may also be referred to as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, a client, or some other suitable terminology. In some scenarios, the term UE may also apply to one or more companion devices such as in a device constellation arrangement. One or more of these devices may collectively access the network and/or individually access the network.

Referring again to FIG. 1, in certain aspects, the UE 104 may include the PTRS setting component 198. The PTRS setting component 198 may be configured to transmit or receive a first transmission of a physical channel, where the physical channel includes one of a PDSCH or a PUSCH; and transmit or receive a subsequent retransmission of the physical channel, where the retransmission of the physical channel includes a PTRS having a pattern that is independent of whether the first transmission was an initial transmission or a prior retransmission. In certain aspects, the base station 102 may include the PTRS setting component 199. The PTRS setting component 199 may be configured to transmit or receive a first transmission of a physical channel, where the physical channel includes one of a PDSCH or a PUSCH, where the first transmission of the physical channel includes a PTRS having a pattern; and transmit or receive a subsequent retransmission of the physical channel, where the subsequent retransmission of the physical channel includes a PTRS having the pattern, wherein the pattern is independent of whether the first transmission was an initial transmission or a prior retransmission. Although the following description may be focused on 5G NR, the concepts described herein may be applicable to other similar areas, such as LTE, LTE-A, CDMA, GSM, and other wireless technologies.

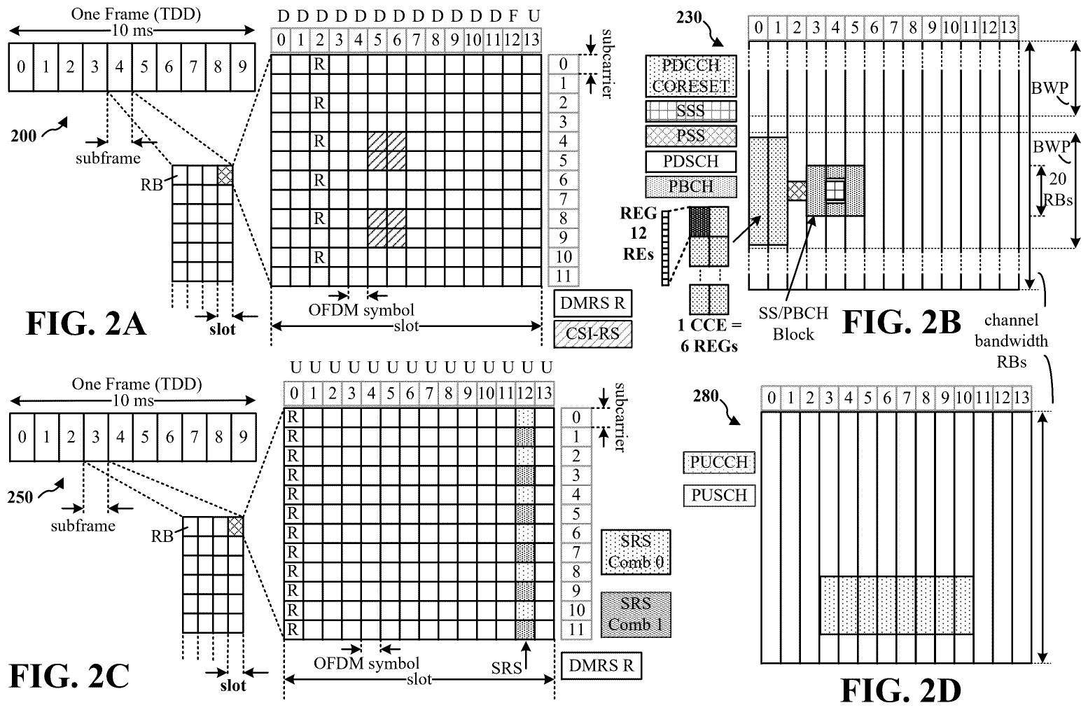

FIG. 2A is a diagram 200 illustrating an example of a first subframe within a 5G NR frame structure. FIG. 2B is a diagram 230 illustrating an example of DL channels within a 5G NR subframe. FIG. 2C is a diagram 250 illustrating an example of a second subframe within a 5G NR frame structure. FIG. 2D is a diagram 280 illustrating an example of UL channels within a 5G NR subframe. The 5G NR frame structure may be frequency division duplexed (FDD) in which for a particular set of subcarriers (carrier system bandwidth), subframes within the set of subcarriers are dedicated for either DL or UL, or may be time division duplexed (TDD) in which for a particular set of subcarriers (carrier system bandwidth), subframes within the set of subcarriers are dedicated for both DL and UL. In the examples provided by FIGS. 2A, 2C, the 5G NR frame structure is assumed to be TDD, with subframe 4 being configured with slot format 28 (with mostly DL), where D is DL, U is UL, and F is flexible for use between DL/UL, and subframe 3 being configured with slot format 1 (with all UL). While subframes 3, 4 are shown with slot formats 1, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description infra applies also to a 5G NR frame structure that is TDD.

FIGS. 2A-2D illustrate a frame structure, and the aspects of the present disclosure may be applicable to other wireless communication technologies, which may have a different frame structure and/or different channels. A frame (10 ms) may be divided into 10 equally sized subframes (1 ms). Each subframe may include one or more time slots. Subframes may also include mini-slots, which may include 7, 4, or 2 symbols. Each slot may include 14 or 12 symbols, depending on whether the cyclic prefix (CP) is normal or extended. For normal CP, each slot may include 14 symbols, and for extended CP, each slot may include 12 symbols. The symbols on DL may be CP orthogonal frequency division multiplexing (OFDM) (CP-OFDM) symbols. The symbols on UL may be CP-OFDM symbols (for high throughput scenarios) or discrete Fourier transform (DFT) spread OFDM (DFT-s-OFDM) symbols (for power limited scenarios; limited to a single stream transmission). The number of slots within a subframe is based on the CP and the numerology. The numerology defines the subcarrier spacing (SCS) (see Table 1). The symbol length/duration may scale with 1/SCS.

TABLE 1
Numerology, SCS, and CP

| | SCS | |
|---|---|---|
| μ | Δf = 2^{μ} · 15[kHz] | Cyclic prefix |
| 0 | 15 | Normal |
| 1 | 30 | Normal |
| 2 | 60 | Normal, |
| | | Extended |
| 3 | 120 | Normal |
| 4 | 240 | Normal |
| 5 | 480 | Normal |
| 6 | 960 | Normal |

For normal CP (14 symbols/slot), different numerologies μ 0 to 4 allow for 1, 2, 4, 8, and 16 slots, respectively, per subframe. For extended CP, the numerology 2 allows for 4 slots per subframe. Accordingly, for normal CP and numerology μ, there are 14 symbols/slot and 24 slots/subframe. The subcarrier spacing may be equal to 2^{μ}*15 kHz, where u is the numerology 0 to 4. As such, the numerology μ=0 has a subcarrier spacing of 15 kHz and the numerology μ=4 has a subcarrier spacing of 240 kHz. The symbol length/duration is inversely related to the subcarrier spacing. FIGS. 2A-2D provide an example of normal CP with 14 symbols per slot and numerology μ=2 with 4 slots per subframe. The slot duration is 0.25 ms, the subcarrier spacing is 60 kHz, and the symbol duration is approximately 16.67 μs. Within a set of frames, there may be one or more different bandwidth parts (BWPs) (see FIG. 2B) that are frequency division multiplexed. Each BWP may have a particular numerology and CP (normal or extended).

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 2A, some of the REs carry reference (pilot) signals (RS) for the UE. The RS may include demodulation RS (DM-RS) (indicated as R for one particular configuration, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 2B illustrates an example of various DL channels within a subframe of a frame. The physical downlink control channel (PDCCH) carries DCI within one or more control channel elements (CCEs) (e.g., 1, 2, 4, 8, or 16 CCEs), each CCE including six RE groups (REGs), each REG including 12 consecutive REs in an OFDM symbol of an RB. A PDCCH within one BWP may be referred to as a control resource set (CORESET). A UE is configured to monitor PDCCH candidates in a PDCCH search space (e.g., common search space, UE-specific search space) during PDCCH monitoring occasions on the CORESET, where the PDCCH candidates have different DCI formats and different aggregation levels. Additional BWPs may be located at greater and/or lower frequencies across the channel bandwidth. A primary synchronization signal (PSS) may be within symbol 2 of particular subframes of a frame. The PSS is used by a UE 104 to determine subframe/symbol timing and a physical layer identity. A secondary synchronization signal (SSS) may be within symbol 4 of particular subframes of a frame. The SSS is used by a UE to determine a physical layer cell identity group number and radio frame timing. Based on the physical layer identity and the physical layer cell identity group number, the UE can determine a physical cell identifier (PCI). Based on the PCI, the UE can determine the locations of the DM-RS. The physical broadcast channel (PBCH), which carries a master information block (MIB), may be logically grouped with the PSS and SSS to form a synchronization signal (SS)/PBCH block (also referred to as SS block (SSB)). The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 2C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 2D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and hybrid automatic repeat request (HARQ) acknowledgment (ACK) (HARQ-ACK) feedback (i.e., one or more HARQ ACK bits indicating one or more ACK and/or negative ACK (NACK)). The PUSCH carries data, and may additionally be used to carry a buffer status report (BSR), a power headroom report (PHR), and/or UCI.

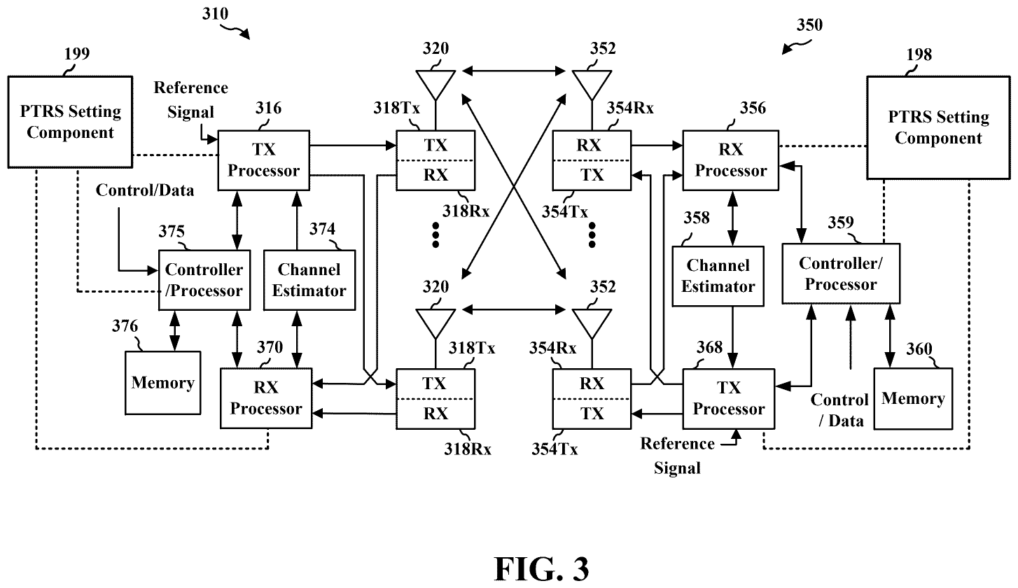

FIG. 3 is a block diagram of a base station 310 in communication with a UE 350 in an access network. In the DL, Internet protocol (IP) packets may be provided to a controller/processor 375. The controller/processor 375 implements layer 3 and layer 2 functionality. Layer 3 includes a radio resource control (RRC) layer, and layer 2 includes a service data adaptation protocol (SDAP) layer, a packet data convergence protocol (PDCP) layer, a radio link control (RLC) layer, and a medium access control (MAC) layer. The controller/processor 375 provides RRC layer functionality associated with broadcasting of system information (e.g., MIB, SIBs), RRC connection control (e.g., RRC connection paging, RRC connection establishment, RRC connection modification, and RRC connection release), inter radio access technology (RAT) mobility, and measurement configuration for UE measurement reporting; PDCP layer functionality associated with header compression/decompression, security (ciphering, deciphering, integrity protection, integrity verification), and handover support functions; RLC layer functionality associated with the transfer of upper layer packet data units (PDUs), error correction through ARQ, concatenation, segmentation, and reassembly of RLC service data units (SDUs), re-segmentation of RLC data PDUs, and reordering of RLC data PDUs; and MAC layer functionality associated with mapping between logical channels and transport channels, multiplexing of MAC SDUs onto transport blocks (TBs), demultiplexing of MAC SDUs from TBs, scheduling information reporting, error correction through HARQ, priority handling, and logical channel prioritization.

The transmit (TX) processor 316 and the receive (RX) processor 370 implement layer 1 functionality associated with various signal processing functions. Layer 1, which includes a physical (PHY) layer, may include error detection on the transport channels, forward error correction (FEC) coding/decoding of the transport channels, interleaving, rate matching, mapping onto physical channels, modulation/demodulation of physical channels, and MIMO antenna processing. The TX processor 316 handles mapping to signal constellations based on various modulation schemes (e.g., binary phase-shift keying (BPSK), quadrature phase-shift keying (QPSK), M-phase-shift keying (M-PSK), M-quadrature amplitude modulation (M-QAM)). The coded and modulated symbols may then be split into parallel streams. Each stream may then be mapped to an OFDM subcarrier, multiplexed with a reference signal (e.g., pilot) in the time and/or frequency domain, and then combined together using an Inverse Fast Fourier Transform (IFFT) to produce a physical channel carrying a time domain OFDM symbol stream. The OFDM stream is spatially precoded to produce multiple spatial streams. Channel estimates from a channel estimator 374 may be used to determine the coding and modulation scheme, as well as for spatial processing. The channel estimate may be derived from a reference signal and/or channel condition feedback transmitted by the UE 350. Each spatial stream may then be provided to a different antenna 320 via a separate transmitter 318Tx. Each transmitter 318Tx may modulate a radio frequency (RF) carrier with a respective spatial stream for transmission.

At the UE 350, each receiver 354Rx receives a signal through its respective antenna 352. Each receiver 354Rx recovers information modulated onto an RF carrier and provides the information to the receive (RX) processor 356. The TX processor 368 and the RX processor 356 implement layer 1 functionality associated with various signal processing functions. The RX processor 356 may perform spatial processing on the information to recover any spatial streams destined for the UE 350. If multiple spatial streams are destined for the UE 350, they may be combined by the RX processor 356 into a single OFDM symbol stream. The RX processor 356 then converts the OFDM symbol stream from the time-domain to the frequency domain using a Fast Fourier Transform (FFT). The frequency domain signal includes a separate OFDM symbol stream for each subcarrier of the OFDM signal. The symbols on each subcarrier, and the reference signal, are recovered and demodulated by determining the most likely signal constellation points transmitted by the base station 310. These soft decisions may be based on channel estimates computed by the channel estimator 358. The soft decisions are then decoded and deinterleaved to recover the data and control signals that were originally transmitted by the base station 310 on the physical channel. The data and control signals are then provided to the controller/processor 359, which implements layer 3 and layer 2 functionality.

The controller/processor 359 can be associated with at least one memory 360 that stores program codes and data. The at least one memory 360 may be referred to as a computer-readable medium. In the UL, the controller/processor 359 provides demultiplexing between transport and logical channels, packet reassembly, deciphering, header decompression, and control signal processing to recover IP packets. The controller/processor 359 is also responsible for error detection using an ACK and/or NACK protocol to support HARQ operations.

Similar to the functionality described in connection with the DL transmission by the base station 310, the controller/processor 359 provides RRC layer functionality associated with system information (e.g., MIB, SIBs) acquisition, RRC connections, and measurement reporting; PDCP layer functionality associated with header compression/decompression, and security (ciphering, deciphering, integrity protection, integrity verification); RLC layer functionality associated with the transfer of upper layer PDUs, error correction through ARQ, concatenation, segmentation, and reassembly of RLC SDUs, re-segmentation of RLC data PDUs, and reordering of RLC data PDUs; and MAC layer functionality associated with mapping between logical channels and transport channels, multiplexing of MAC SDUs onto TBs, demultiplexing of MAC SDUs from TBs, scheduling information reporting, error correction through HARQ, priority handling, and logical channel prioritization.

Channel estimates derived by a channel estimator 358 from a reference signal or feedback transmitted by the base station 310 may be used by the TX processor 368 to select the appropriate coding and modulation schemes, and to facilitate spatial processing. The spatial streams generated by the TX processor 368 may be provided to different antenna 352 via separate transmitters 354Tx. Each transmitter 354Tx may modulate an RF carrier with a respective spatial stream for transmission.

The UL transmission is processed at the base station 310 in a manner similar to that described in connection with the receiver function at the UE 350. Each receiver 318Rx receives a signal through its respective antenna 320. Each receiver 318Rx recovers information modulated onto an RF carrier and provides the information to a RX processor 370.

The controller/processor 375 can be associated with at least one memory 376 that stores program codes and data. The at least one memory 376 may be referred to as a computer-readable medium. In the UL, the controller/processor 375 provides demultiplexing between transport and logical channels, packet reassembly, deciphering, header decompression, control signal processing to recover IP packets. The controller/processor 375 is also responsible for error detection using an ACK and/or NACK protocol to support HARQ operations.

At least one of the TX processor 368, the RX processor 356, and the controller/processor 359 may be configured to perform aspects in connection with the PTRS setting component 198 of FIG. 1.

At least one of the TX processor 316, the RX processor 370, and the controller/processor 375 may be configured to perform aspects in connection with the PTRS setting component 199 of FIG. 1.

The present disclosure provides methods and apparatus for determining the PTRS pattern in cases where the DCI of the initial transmission (e.g., determined to be an initial transmission using a new data indicator (NDI) value) is not received at the UE. The absence of DCI may lead to discrepancies between the base station and UE regarding the details of the “initial transmission,” causing the UE and base station to use different MCS values to determine the PTRS pattern and density for subsequent retransmission. In some examples, a fixed MCS may be used to determine the PTRS pattern and density for the subsequent retransmission on the PDSCH or PUSCH. The fixed MCS can be a predetermined value in a wireless communication standard or configured by the network. In some examples, a fixed PTRS pattern and density may be used for the retransmissions of PDSCH or PUSCH. The fixed pattern and density can be predetermined in the standard or configured by the network. In some examples, when the UE and base station can associate PTRS with different codewords during a retransmission, the PTRS may be consistently associated with a fixed codeword (e.g., the first codeword) in the retransmissions of PDSCH or PUSCH.

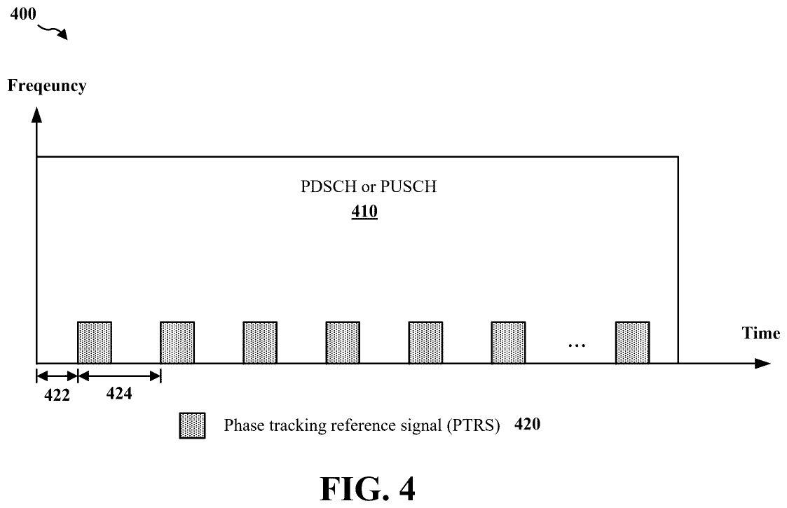

In wireless communications, the phase tracking reference signal (PTRS) is a reference signal inserted in the data transmission (e.g., PDSCH or PUSCH) to enable the receiver to accurately estimate phase noise and subsequently remove or compensate for it. FIG. 4 is a diagram 400 illustrating an example of a PTRS in data transmission. In FIG. 4, the data transmission 410, such as PDSCH or PUSCH, may include a PTRS 420. The PTRS 420 may have a certain pattern and density that defines its distribution in the time or frequency domain. For example, the pattern and density of the PTRS 420 may include the offset 422 of the PTRS and the periodicity 424 of the PTRS 420. In some aspects, the term “pattern and density” of a PTRS may sometimes be referred to simply as the “pattern” of a PTRS.

The pattern and density of the PTRS may be determined by the modulation and coding scheme (MCS) of the scheduled codeword, which constitutes the data being transmitted. For example, if a UE is configured with the higher layer parameter phaseTrackingRS in configuration DMRS-DownlinkConfig, the higher layer parameters time Density and frequencyDensity in PTRS-DownlinkConfig may indicate the threshold value ptrs-MCSᵢ, i=1, 2, 3 and N_{RB,i}, i=0, 1, where N_{RB,i} represents the number of scheduled resource blocks (RBs). In some examples, if either or both of the additional higher layer parameters timeDensity and frequencyDensity are configured, and the radio network temporary identifier (RNTI) equals cell radio network temporary identifier (C-RNTI), configured scheduling RNTI (CS-RNTI), or MCS-C-RNTI, the UE may assume that PTRS antenna port's presence and pattern is a function of the corresponding scheduled MCS of the corresponding codeword and scheduled bandwidth in corresponding bandwidth part. In some examples, if the higher layer parameter timeDensity given by PTRS-DownlinkConfig is not configured, the UE may assume L_{PT-RS}=1, where L_{PT-RS} represents the density of the PTRS in the time domain. In some examples, if the higher layer parameter frequencyDensity given by PTRS-DownlinkConfig is not configured, the UE may assume K_{PT-RS}=2, where K_{PT-RS} represents the density of the PTRS in the frequency domain.

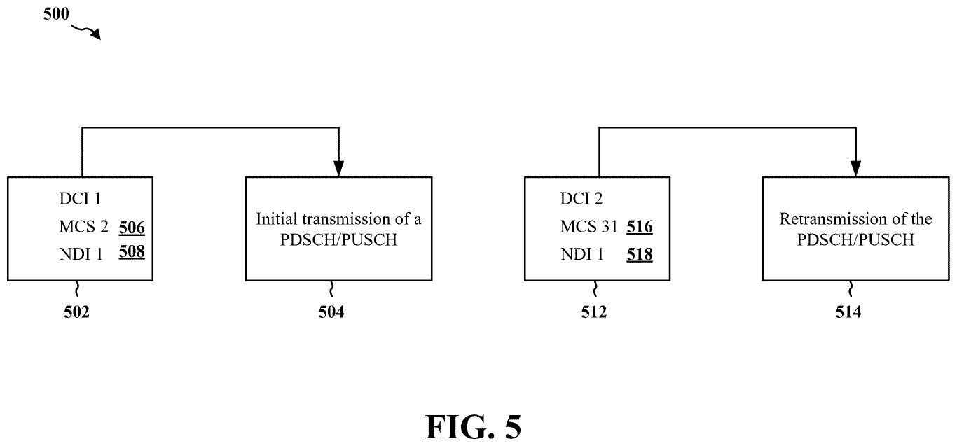

In some examples, the data in the initial transmission (e.g., via PDSCH or PUSCH) may not be correctly received due to issues such as interference or noise, and the data may be retransmitted (e.g., via PDSCH or PUSCH). For example, the retransmission of data via PDSCH or PUSCH may be triggered when the transmitting device receives a negative acknowledgement (NACK) from the receiving device, indicating that an error was detected in the received data. The retransmission of the data through PDSCH or PUSCH may be identified if the NDI field in the downlink control information (DCI) remains unchanged from a previous transmission within the same hybrid automatic repeat request (HARQ) process identifier (ID). FIG. 5 is a diagram 500 illustrating an example of a retransmission of the PDSCH or PUSCH. In FIG. 5, the first DCI 502 for the initial transmission of a PDSCH or PUSCH (e.g., 504) may include an MCS (e.g., MCS 2 506) and an NDI (e.g., NDI 1 508). If the second DCI 512 includes an NDI 518 that is the same as the NDI 508 in the first DCI 502, the transmission (e.g., 514) associated with the second DCI 512 is a retransmission of the initial transmission (e.g., 504), assuming these transmissions share the same HARQ ID.

In some examples, during the retransmission (e.g., at 514) of data through PDSCH or PUSCH, the MCS used to determine the pattern and density for a PTRS in the retransmission (e.g., in 514) may follow certain rules. For example, if the retransmission involves what is termed as “reserved” MCS (i.e., the largest three or four MCS values in the MCS table), such as MCS 31 516, the MCS that was used during the initial transmission of the transport block (e.g., codeword), such as MCS 2 506 in the first DCI 502, may be reused to determine the pattern and density of the PTRS in the retransmission (e.g., 514). On the other hand, if a nominal MCS, which is not a reserved MCS, is used for the retransmission, the actual MCS applied during the retransmission may be used to determine the pattern and density of the PTRS in the retransmission.

However, when using these rules to determine the pattern and density of the PTRS in the retransmission, an issue may arise when the UE misses the DCI. The missed DCI may lead to a mismatch in understanding between the base station (e.g., a gNB) and the UE regarding the details of the initial transmission. As a result, the base station (e.g., a gNB) and UE may employ different MCS when determining the pattern and density of the PTRS for the retransmission.

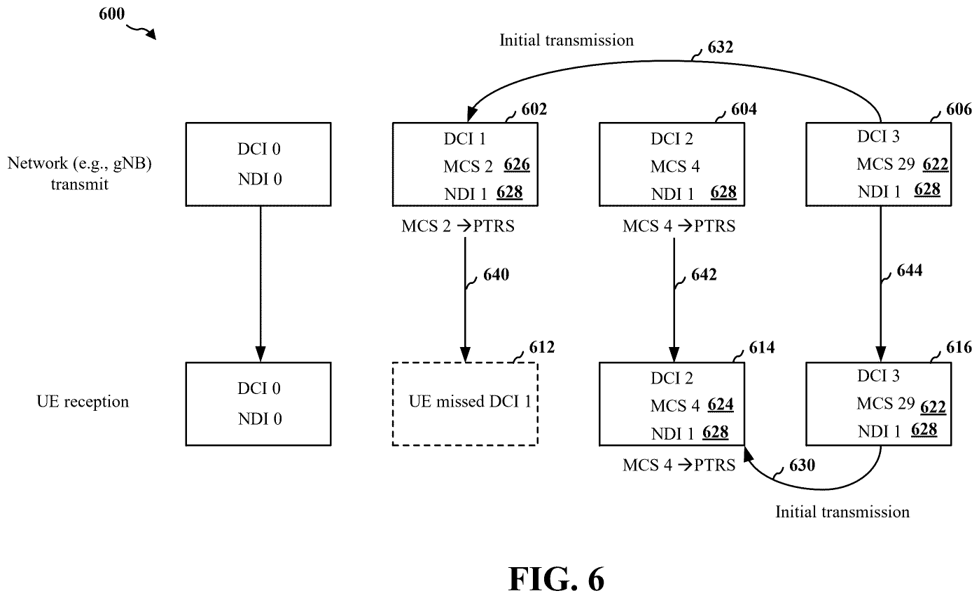

FIG. 6 is a diagram 600 illustrating an example of different MCS used by the base station and the UE due to missed DCI. In FIG. 6, the transmission 640 of the first DCI 602 may not be received by the UE (e.g., due to interference or noise) at 612. Subsequently, the base station may transmit the second DCI 604 at 642, which is received by the UE at 614. When the base station schedules a retransmission, it may transmit the third DCI 606 at 644, which is received by the UE at 616. If the third DCI 606 includes a reserved MCS (e.g., MCS 29 622), the UE, based on the NDI (e.g., NDI 1 628) in the DCI, may, at 630, considered the second DCI it received at 614 as the DCI associated with the initial transmission. Hence, the UE may use the MCS in the second DCI (e.g., MCS 4 624) to determine the pattern and density of the PTRS in the retransmission. On the other hand, the base station may, at 632, consider the first DCI it transmitted at 602 as the DCI associated with the initial transmission based on the NDI (e.g., NDI 1 628). Hence, the base station may use the MCS in the first DCI 602 (e.g., MCS 2 626) to determine the pattern and density of the PTRS in the retransmission. As a result, the base station and the UE may employ different MCS (e.g., MCS 2 626 and MCS 4 624, respectively) to determine the pattern and density of the PTRS in the retransmission. Such discrepancies may adversely impact the effectiveness of wireless communication.

Example aspects provide methods and apparatus to enable the use of a default PTRS pattern and density to ensure the consistency of the PTRS settings during retransmissions. In some aspects, a fixed MCS may be used to determine the PTRS pattern and density for retransmissions (e.g., retransmission of PDSCH or PUSCH). In some examples, the value of this fixed MCS may be a hardcoded value in the wireless communication standards, a predetermined value, or a pre-agreed value between the transmitter and the receiver. In some examples, the value of this fixed MCS may be dynamically configured by the network. For example, the UE may receive an MCS configuration from the base station, and the MCS configuration may indicate the fixed MCS.

In some examples, a fixed pattern and density for a PTRS may be used for these retransmissions (e.g., retransmission of PDSCH or PUSCH). Similar to the fixed MCS, the fixed pattern and density for a PTRS may be hardcoded into the wireless communication standards. In some examples, the fixed pattern and density may be a preconfigured pattern and density setting or a pre-agreed pattern and density between the transmitter and the receiver. In some examples, the fixed pattern and density of the PTRS may be dynamically configured by the network. For example, the UE may receive a pattern configuration from the base station, and the pattern configuration may indicate the fixed pattern and density of the PTRS. This approach ensures consistent PTRS settings across various transmissions and retransmissions, even if a DCI (e.g., the first DCI transmitted at 602) is not received by the UE.

In some aspects, the transmissions of the PDSCH or PUSCH may have multiple (e.g., two) codewords, and the PTRS may be associated with one codeword of the multiple (e.g., two) codewords. For example, the PTRS may be associated with the codeword that has the larger MCS value. As used herein, a “codeword” refers to a block of data that has been encoded and modulated and is ready for transmission. The size and structure of a codeword may depend on the MCS. When a codeword undergoes retransmission, the MCS used for the initial transmission of the codeword or the transport block (TB) may be used to determine this association between the codeword and the PTRS in the retransmission.

However, as shown in FIG. 6, due to missed DCI (e.g., at 612), the base station and the UE may identify the initial transmission differently. For example, the base station may identify the first DCI at 602 as the DCI associated with the initial transmission, while the UE may consider the second DCI at 614 as the DCI associated with the initial transmission. As a result, the base station and the UE may associate the PTRS with different codewords during the retransmission of the PDSCH or PUSCH.

In some aspects, to ensure a consistent PTRS setting in the retransmission, the PTRS may be associated with a fixed codeword of the multiple (e.g., two) codewords in the retransmission of PDSCH or PUSCH. For example, the PTRS may be consistently associated with the first codeword of the multiple (e.g., two) codewords for the retransmission of PDSCH or PUSCH.

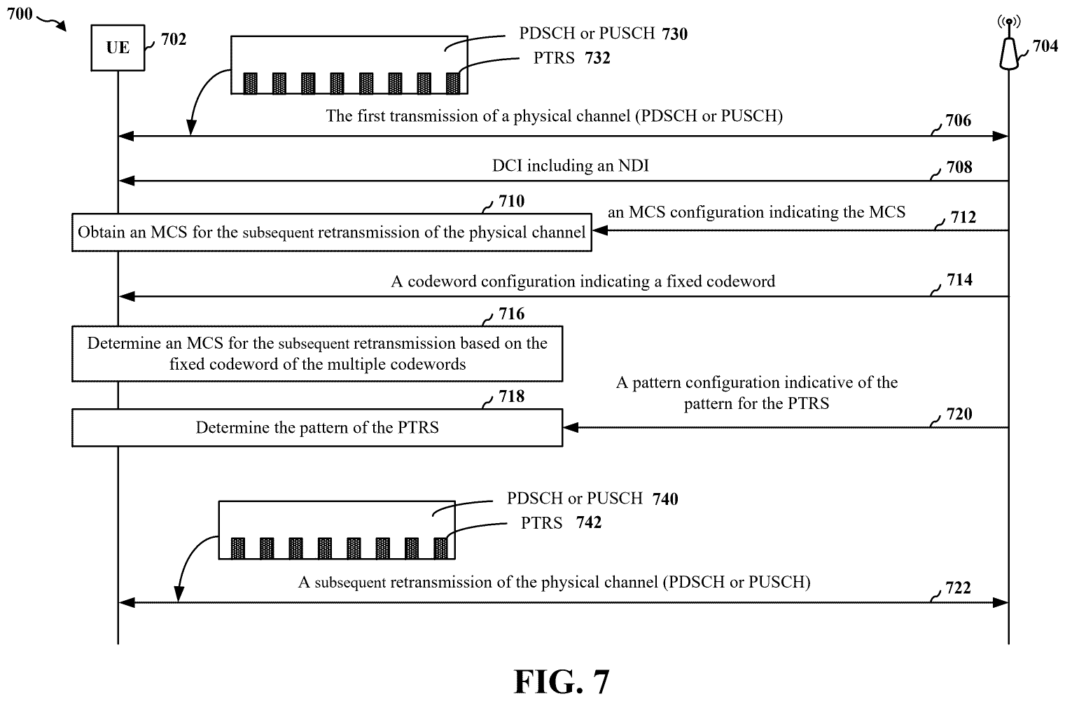

FIG. 7 is a call flow diagram 700 illustrating a method of wireless communication in accordance with various aspects of this present disclosure. Various aspects are described in connection with a UE 702 and a base station 704. The aspects may be performed by the UE 702 or the base station 704 in aggregation and/or by one or more components of a base station 704 (e.g., a CU 110, a DU 130, and/or an RU 140).

As shown in FIG. 7, at 706, the UE 702 may transmit or receive a first transmission of a physical channel. As used herein, “first transmission” is used since it comes before the transmission of a subsequent retransmission that both the UE 702 and the base station 704 agree is a retransmission. Additionally, “first transmission” is used (as opposed to “initial transmission”) since the UE 702 and the base station 704 may both have different understandings of whether the “first transmission” is an initial transition (associated with an NDI toggle) or is a prior retransmission occurring before the subsequent retransmission, as will be discussed in greater detail below. For example, referring to FIG. 6, the transmission 642 of DCI 2 may be associated with the first transmission. For example, the physical channel may be a PDSCH or PUSCH 730. In some examples, the UE 702 may transmit a first transmission of a PUSCH to base station 704 at 706. In some examples, the UE 702 may receive a first transmission of a PDSCH from base station 704 at 706. The PDSCH or PUSCH 730 may include a PTRS 732, which may have a pattern. The pattern of the PTRS may define the distribution of the PTRS in the time or frequency domain. For example, in FIG. 4, the pattern of the PTRS 420 may include the offset 422 of the PTRS and the periodicity 424 of the PTRS 420.

At 708, the UE 702 may receive DCI from base station 704. The DCI may include an NDI field, and the retransmission of the physical channel (e.g., at 722) may be based on the NDI. For example, referring to FIG. 6, the UE may receive the third DCI at 616. The third DCI may include an NDI field (e.g., NDI 1 628). The NDI in the third DCI (e.g., at 616) matching the NDI in the previous PDSCH or PUSCH transmission having the same HARQ process ID may indicate a retransmission of the PDSCH or PUSCH.

At 710, the UE 702 may obtain an MCS for the retransmission of the physical channel (e.g., PDSCH or PUSCH). In some examples, the UE 702 may obtain the MCS based on an MCS configuration received from base station 704 (e.g., at 712). The MCS configuration may indicate the MCS. In some examples, the MCS may be a preconfigured MCS. For example, the MCS may be a hardcoded value in a wireless communication standard, a predefined MCS, or a pre-agreed MCS between the transmitter and the receiver.

In some examples, at 714, the UE 702 may receive a codeword configuration from base station 704. The codeword configuration may indicate a fixed codeword among multiple codewords for a retransmission (e.g., at 722) of the physical channel (e.g., PDSCH or PUSCH).

At 716, the UE 702 may determine an MCS for the retransmission (e.g., at 722) based on the fixed codeword of the multiple codewords.

At 718, the UE 702 may determine the pattern of the PTRS for the retransmission. The pattern of the PTRS for the retransmission may be determined in various ways. In some examples, the pattern for the PTRS may be determined based on the MCS obtained at 710. In some examples, the pattern for the PTRS may be determined based on the fixed codeword obtained at 716. In some examples, the pattern for the PTRS may be a preconfigured pattern. For example, the pattern of the PTRS may a hardcoded pattern in a wireless communication standard, a predefined pattern, or a pre-agreed pattern between the transmitter and the receiver. In some examples, the pattern of the PTRS for the retransmission may be indicated by base station 704. For example, at 720, the UE 702 may receive a pattern configuration from base station 704, and the pattern configuration may indicate the pattern for the PTRS.

At 722, the UE 702 may transmit or receive a subsequent retransmission of the physical channel. For example, the physical channel may be a PDSCH or PUSCH 740. The subsequent retransmission of the physical channel may include a PTRS 742 having the pattern, which may be determined at 718. The pattern of the PTRS 742 may be independent on whether the first transmission (e.g., at 706) was an initial transmission or a prior retransmission. For example, referring to FIG. 6, the transmission 644 may be associated with a subsequent retransmission of the physical channel. Since the transmission 640 of DCI 1 was not received by the UE at 612, the base station and the UE may interpret the first transmission (e.g., transmission 642) differently. The UE, unaware of transmission 640, may consider transmission 642 of DCI 2 to be associated with the initial transmission based on the NDI value (e.g., NDI 1 628). On the other hand, the base station may consider the transmission 640 of DCI 1 to be associated with the initial transmission based on the NDI value (e.g., NDI 1 628) and may consider the transmission 642 of DCI 2 to be associated with a prior retransmission of transmission 640. Since the pattern of the PTRS 742 is determined based on a fixed value that is unrelated to the initial transmission, such as a fixed MCS or a fixed codeword, the base station and the UE may use the same PTRS pattern, even though they have different interpretations of what the initial transmission is. Hence, using a fixed PTRS pattern for retransmissions addresses the discrepancies and inconsistencies resulting from different PTRS patterns that may otherwise be used by the base station and the UE due to missed DCI.

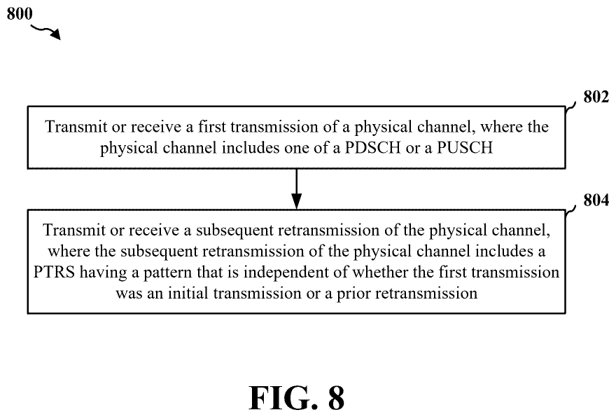

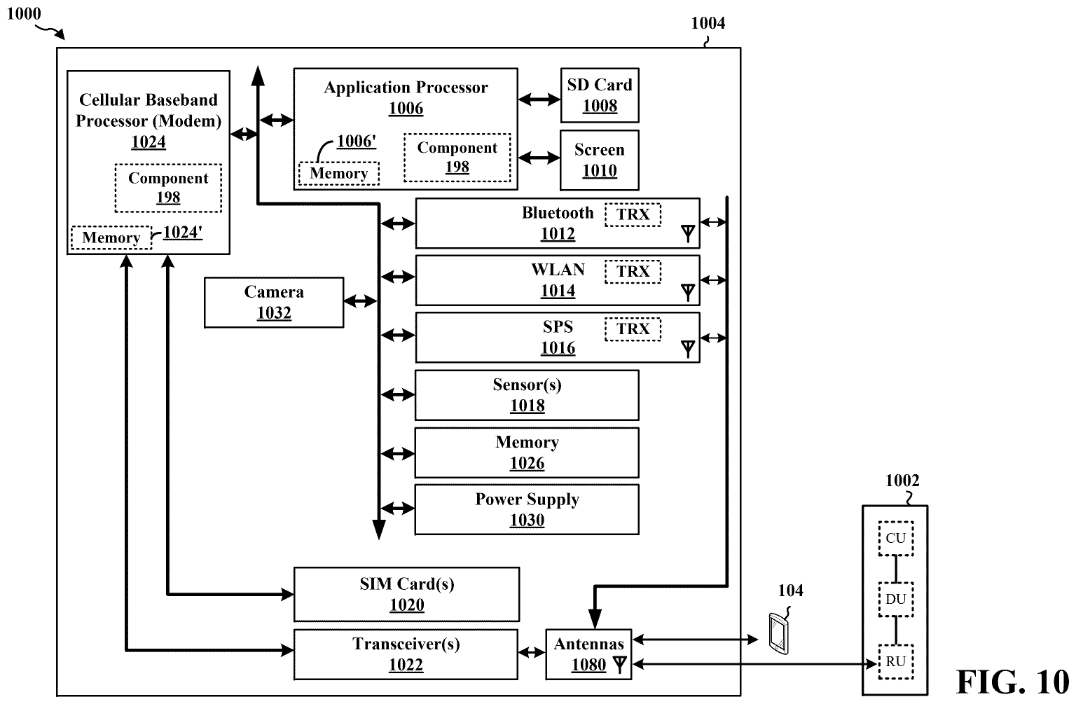

FIG. 8 is a flowchart 800 illustrating methods of wireless communication at a UE in accordance with various aspects of the present disclosure. The method may be performed by a UE in coordination with a network entity. The network entity may be a base station, or a component of a base station, in the access network of FIG. 1 or a core network component (e.g., base station 102, 310, 704; or the network entity 1002 in the hardware implementation of FIG. 10). The UE may be the UE 104, 350, 702, or the apparatus 1004 in the hardware implementation of FIG. 10. By using a fixed PTRS setting, which may be determined based on a fixed MCS or a fixed codeword, for the subsequent retransmissions of signals on the PDSCH or PUSCH, the methods address and mitigate the discrepancies and inconsistencies resulting from missed DCI about initial transmission statuses, thereby enhancing the reliability and efficiency of wireless communication. Additionally, by consistently using a fixed MCS or a fixed codeword for PTRS in retransmissions, the methods simplify the decision-making process for PTRS settings in retransmissions, thereby lowering the computational burden on the network or UE.

As shown in FIG. 8, at 802, the UE may transmit or receive a first transmission of a physical channel. The physical channel may include one of a PDSCH or a PUSCH. FIG. 6 and FIG. 7 illustrate various aspects in connection with flowchart 800. For example, referring to FIG. 7, at 706, the UE 702 may transmit or receive a first transmission of a physical channel. The physical channel may be a PDSCH or PUSCH 730. Referring to FIG. 6, the transmission 642 of DCI 2 may be associated with the first transmission of the physical channel. In some aspects, 802 may be performed by the PTRS setting component 198.

At 804, the UE may transmit or receive a subsequent retransmission of the physical channel. The subsequent retransmission of the physical channel may include a PTRS with a pattern that is independent of whether the first transmission was an initial transmission or a prior retransmission. For example, referring to FIG. 7, at 722, the UE 702 may transmit or receive a subsequent retransmission of the physical channel. The retransmission of the physical channel may include a PTRS 742 having a pattern. The pattern may be independent of whether the first transmission (at 706) was an initial transmission or a prior retransmission. Referring to FIG. 6, the transmission 644 of DCI 3 may be associated with the subsequent retransmission of the physical channel. In some aspects, 804 may be performed by the PTRS setting component 198.

In some aspects, transmitting or receiving the first transmission of the physical channel may include transmitting, to a network entity, the first transmission of the PUSCH, and transmitting or receiving the subsequent retransmission of the physical channel may include transmitting, to the network entity, the subsequent retransmission of the PUSCH. For example, referring to FIG. 7, at 706, the UE 702 may transmit to a network entity (base station 704) the first transmission of the PUSCH (e.g., 730), and, at 722, transmit to the network entity (base station 704) the subsequent retransmission of the PUSCH (e.g., 740).

In some aspects, transmitting or receiving the first transmission of the physical channel may include receiving, from a network entity, the first transmission of the PDSCH, and transmitting or receiving the subsequent retransmission of the physical channel may include receiving, from the network entity, the subsequent retransmission of the PDSCH. For example, referring to FIG. 7, at 706, the UE 702 may receive from a network entity (base station 704) the first transmission of the PDSCH (e.g., 730), and, at 722, receive from the network entity (base station 704) the subsequent retransmission of the PDSCH (e.g., 740).

In some aspects, the first transmission of the physical channel may include the PTRS having the pattern. For example, referring to FIG. 7, the first transmission of the physical channel (e.g., at 730) may include the PTRS 732 having the pattern.

In some aspects, the UE may receive, from a network entity, DCI including an NDI. The subsequent retransmission of the physical channel may be based on the NDI. For example, referring to FIG. 7, the UE 702 may, at 708, receive from a network entity (base station 704) DCI. Referring to FIG. 6, the DCI (e.g., at 616) may include an NDI 628. The NDI 628 in the DCI (e.g., at 616) matching the NDI in the previous PDSCH or PUSCH transmission having the same HARQ process ID may indicate a retransmission of the PDSCH or PUSCH.

In some aspects, the pattern may be based on a configured pattern. For example, referring to FIG. 7, the pattern (e.g., the pattern determined at 718) may be based on a configured pattern (e.g., a pattern hardcoded in a wireless communication standard).

In some aspects, the UE may receive, from a network entity, a pattern configuration indicative of the pattern for the PTRS. For example, referring to FIG. 7, the UE 702 may, at 720, receive from a network entity (base station 704) a pattern configuration indicative of the pattern for the PTRS.

In some aspects, the UE may obtain an MCS for the subsequent retransmission of the physical channel; and determine the pattern of the PTRS based on the MCS. For example, referring to FIG. 7, the UE 702 may, at 710, obtain an MCS for the subsequent retransmission of the physical channel and, at 718, determine the pattern of the PTRS based on the MCS.

In some aspects, obtaining the MCS may include receiving an MCS configuration indicating the MCS, or obtaining the MCS based on a configured MCS. For example, referring to FIG. 7, the UE 702 may obtain the MCS by, at 712, receiving an MCS configuration indicating the MCS from base station 704. In some examples, the UE 702 may obtain the MCS based on a configured MCS (e.g., a preconfigured MCS value in a wireless communication standard, a predefined MCS, or a pre-agreed MCS between the transmitter and the receiver).

In some aspects, the subsequent retransmission of the physical channel may include multiple codewords, and the UE may determine an MCS for the retransmission based on a fixed codeword of the multiple codewords. The UE may further determine the pattern for the PTRS based on the MCS. For example, referring to FIG. 7, the subsequent retransmission of the physical channel may include multiple codewords, and the UE 702 may, at 716, determine an MCS for the subsequent retransmission based on a fixed codeword of the multiple codewords. At 718, the UE 702 may further determine the pattern for the PTRS based on the MCS.

In some aspects, the fixed codeword may be based on a configured codeword. For example, referring to FIG. 7, the fixed codeword (which is used to determine the MCS at 716) may be based on a configured codeword (e.g., a hardcoded value in a wireless communication standard).

In some aspects, the UE may receive, from a network entity, a codeword configuration indicating the fixed codeword. For example, referring to FIG. 7, the UE 702 may, at 714, receive from a network entity (base station 704) a codeword configuration indicating the fixed codeword.

In some aspects, the PTRS in the first transmission of the physical channel may be based on the fixed codeword. For example, referring to FIG. 7, the PTRS 732 in the first transmission of the physical channel (e.g., at 706) may be based on the fixed codeword (e.g., the fixed codeword received at 714).

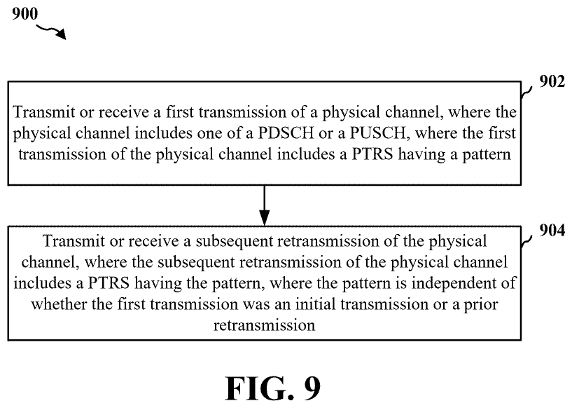

FIG. 9 is a flowchart 900 illustrating methods of wireless communication at a network entity in accordance with various aspects of the present disclosure. The method may be performed by a network entity in coordination with a UE. The network entity may be a base station, or a component of a base station, in the access network of FIG. 1 or a core network component (e.g., base station 102, 310, 704; or the network entity 1002 in the hardware implementation of FIG. 10). The UE may be the UE 104, 350, 702, or the apparatus 1004 in the hardware implementation of FIG. 10. By using a fixed PTRS setting, which may be determined based on a fixed MCS or a fixed codeword, for the subsequent retransmissions of signals on the PDSCH or PUSCH, the methods address and mitigate the discrepancies and inconsistencies resulting from missed DCI about initial transmission statuses, thereby enhancing the reliability and efficiency of wireless communication. Additionally, by consistently using a fixed MCS or a fixed codeword for PTRS in retransmissions, the methods simplify the decision-making process for PTRS settings in retransmissions, thereby lowering the computational burden on the network or UE.

As shown in FIG. 9, at 902, the network entity may transmit or receive a first transmission of a physical channel. The physical channel may include one of a PDSCH or a PUSCH, and the first transmission of the physical channel may include a PTRS having a pattern. FIG. 6 and FIG. 7 illustrate various aspects in connection with flowchart 900. For example, referring to FIG. 7, the network entity (base station 704) may, at 706, transmit or receive a first transmission of a physical channel. The physical channel may include a PDSCH or PUSCH 730, and the first transmission of the physical channel may include a PTRS 732 having a pattern. In some aspects, 902 may be performed by the PTRS setting component 199.

At 904, the network entity may transmit or receive a subsequent retransmission of the physical channel. The subsequent retransmission of the physical channel may include a PTRS with the pattern, and the pattern is independent of whether the first transmission was an initial transmission or a prior retransmission. For example, referring to FIG. 7, the network entity (base station 704) may, at 722, transmit or receive a subsequent retransmission of the physical channel. The subsequent retransmission of the physical channel may include a PTRS 742 having the pattern, and the pattern may be independent of whether the first transmission was an initial transmission or a prior retransmission. In some aspects, 904 may be performed by the PTRS setting component 199.

In some aspects, the network entity may transmit, to a UE, DCI including an NDI, and the subsequent retransmission of the physical channel may be based on the NDI. For example, referring to FIG. 7, the network entity (base station 704) may, at 708, transmit to a UE 702 DCI including an NDI, and the subsequent retransmission of the physical channel (e.g., at 722) may be based on the NDI.

In some aspects, the network entity may transmit, to a UE, a pattern configuration indicative of the pattern for the PTRS. For example, referring to FIG. 7, the network entity (base station 704) may, at 720, transmit to a UE 702 a pattern configuration indicative of the pattern for the PTRS.

In some aspects, the pattern of the PTRS may be based on a fixed MCS for the subsequent retransmission of the physical channel. For example, referring to FIG. 7, the pattern of the PTRS (e.g., the default pattern determined at 718) may be based on a fixed MCS (e.g., the default MCS obtained at 710) for the subsequent retransmission of the physical channel.

In some aspects, the subsequent retransmission of the physical channel may include multiple codewords, and the default pattern for the PTRS may be based on a fixed MCS associated with a fixed codeword of the multiple codewords. For example, referring to FIG. 7, the subsequent retransmission of the physical channel (e.g., at 722) may include multiple codewords, and the pattern for the PTRS 742 may be based on a fixed MCS associated with a fixed codeword of the multiple codewords (e.g., the default codeword at 714).

In some aspects, the network entity may transmit, to a UE, a codeword configuration indicating the fixed codeword. For example, referring to FIG. 7, the network entity (base station 704) may, at 714, transmit to a UE 702 a codeword configuration indicating the fixed codeword.

FIG. 10 is a diagram 1000 illustrating an example of a hardware implementation for an apparatus 1004. The apparatus 1004 may be a UE, a component of a UE, or may implement UE functionality. In some aspects, the apparatus 1004 may include at least one cellular baseband processor (or processing circuitry) 1024 (also referred to as a modem) coupled to one or more transceivers 1022 (e.g., cellular RF transceiver). The cellular baseband processor(s) (or processing circuitry) 1024 may include at least one on-chip memory (or memory circuitry) 1024′. In some aspects, the apparatus 1004 may further include one or more subscriber identity modules (SIM) cards 1020 and at least one application processor (or processing circuitry) 1006 coupled to a secure digital (SD) card 1008 and a screen 1010. The application processor(s) (or processing circuitry) 1006 may include on-chip memory (or memory circuitry) 1006′. In some aspects, the apparatus 1004 may further include a Bluetooth module 1012, a WLAN module 1014, an SPS module 1016 (e.g., GNSS module), one or more sensor modules 1018 (e.g., barometric pressure sensor/altimeter; motion sensor such as inertial measurement unit (IMU), gyroscope, and/or accelerometer(s); light detection and ranging (LIDAR), radio assisted detection and ranging (RADAR), sound navigation and ranging (SONAR), magnetometer, audio and/or other technologies used for positioning), additional memory modules 1026, a power supply 1030, and/or a camera 1032. The Bluetooth module 1012, the WLAN module 1014, and the SPS module 1016 may include an on-chip transceiver (TRX) (or in some cases, just a receiver (RX)). The Bluetooth module 1012, the WLAN module 1014, and the SPS module 1016 may include their own dedicated antennas and/or utilize the antennas 1080 for communication. The cellular baseband processor(s) (or processing circuitry) 1024 communicates through the transceiver(s) 1022 via one or more antennas 1080 with the UE 104 and/or with an RU associated with a network entity 1002. The cellular baseband processor(s) (or processing circuitry) 1024 and the application processor(s) (or processing circuitry) 1006 may each include a computer-readable medium/memory (or memory circuitry) 1024′, 1006′, respectively. The additional memory modules 1026 may also be considered a computer-readable medium/memory (or memory circuitry). Each computer-readable medium/memory (or memory circuitry) 1024′, 1006′, 1026 may be non-transitory. The cellular baseband processor(s) (or processing circuitry) 1024 and the application processor(s) (or processing circuitry) 1006 are each responsible for general processing, including the execution of software stored on the computer-readable medium/memory (or memory circuitry). The software, when executed by the cellular baseband processor(s) (or processing circuitry) 1024/application processor(s) (or processing circuitry) 1006, causes the cellular baseband processor(s) (or processing circuitry) 1024/application processor(s) (or processing circuitry) 1006 to perform the various functions described supra. The cellular baseband processor(s) (or processing circuitry) 1024 and the application processor(s) (or processing circuitry) 1006 are configured to perform the various functions described supra based at least in part of the information stored in the memory (or memory circuitry). That is, the cellular baseband processor(s) (or processing circuitry) 1024 and the application processor(s) (or processing circuitry) 1006 may be configured to perform a first subset of the various functions described supra without information stored in the memory and may be configured to perform a second subset of the various functions described supra based on the information stored in the memory. The computer-readable medium/memory (or memory circuitry) may also be used for storing data that is manipulated by the cellular baseband processor(s) (or processing circuitry) 1024/application processor(s) (or processing circuitry) 1006 when executing software. The cellular baseband processor(s) (or processing circuitry) 1024/application processor(s) (or processing circuitry) 1006 may be a component of the UE 350 and may include the at least one memory 360 and/or at least one of the TX processor 368, the RX processor 356, and the controller/processor 359. In one configuration, the apparatus 1004 may be at least one processor chip (modem and/or application) and include just the cellular baseband processor(s) (or processing circuitry) 1024 and/or the application processor(s) (or processing circuitry) 1006, and in another configuration, the apparatus 1004 may be the entire UE (e.g., see UE 350 of FIG. 3) and include the additional modules of the apparatus 1004.

As discussed supra, the component 198 may be configured to transmit or receive a first transmission of a physical channel, where the physical channel includes one of a PDSCH or a PUSCH; and transmit or receive a subsequent retransmission of the physical channel, where the subsequent retransmission of the physical channel includes a PTRS having a pattern that is independent of whether the first transmission was an initial transmission or a prior retransmission. The component 198 may be further configured to perform any of the aspects described in connection with the flowchart in FIG. 8, and/or performed by the UE 702 in FIG. 7. The component 198 may be within the cellular baseband processor(s) (or processing circuitry) 1024, the application processor(s) (or processing circuitry) 1006, or both the cellular baseband processor(s) (or processing circuitry) 1024 and the application processor(s) (or processing circuitry) 1006. The component 198 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. As shown, the apparatus 1004 may include a variety of components configured for various functions. In one configuration, the apparatus 1004, and in particular the cellular baseband processor(s) (or processing circuitry) 1024 and/or the application processor(s) (or processing circuitry) 1006, includes means for transmitting or receiving a first transmission of a physical channel, where the physical channel includes one of a PDSCH or a PUSCH, and means for transmitting or receiving a subsequent retransmission of the physical channel, where the subsequent retransmission of the physical channel includes a PTRS having a pattern that is independent of whether the first transmission was an initial transmission or a prior retransmission. The apparatus 1004 may further include means for performing any of the aspects described in connection with the flowchart in FIG. 8, and/or aspects performed by the UE 702 in FIG. 7. The means may be the component 198 of the apparatus 1004 configured to perform the functions recited by the means. As described supra, the apparatus 1004 may include the TX processor 368, the RX processor 356, and the controller/processor 359. As such, in one configuration, the means may be the TX processor 368, the RX processor 356, and/or the controller/processor 359 configured to perform the functions recited by the means.

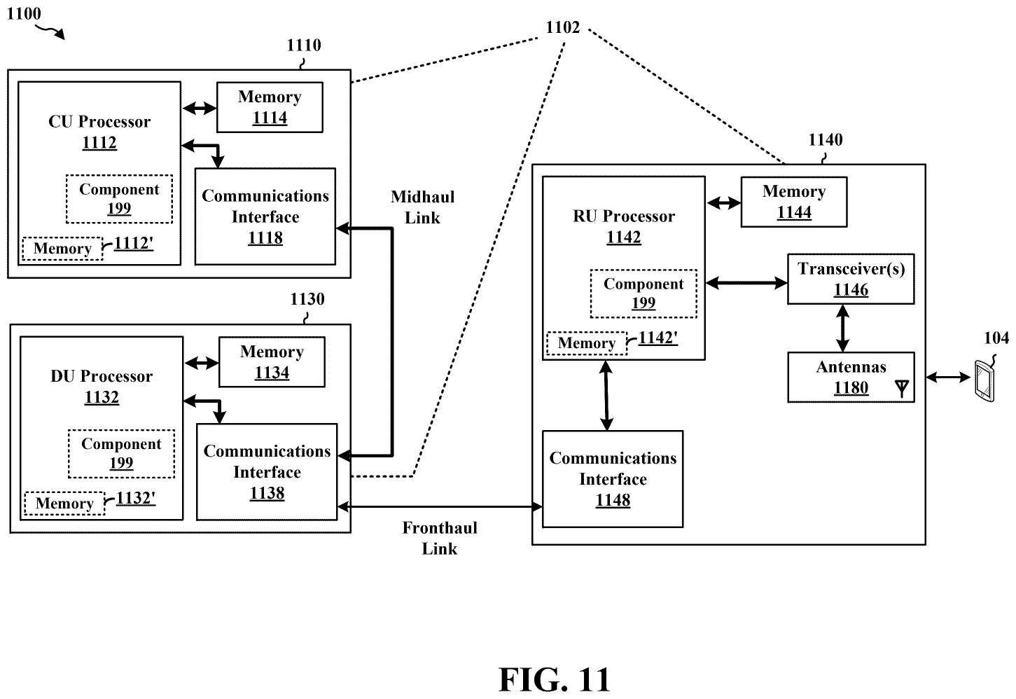

FIG. 11 is a diagram 1100 illustrating an example of a hardware implementation for a network entity 1102. The network entity 1102 may be a BS, a component of a BS, or may implement BS functionality. The network entity 1102 may include at least one of a CU 1110, a DU 1130, or an RU 1140. For example, depending on the layer functionality handled by the component 199, the network entity 1102 may include the CU 1110; both the CU 1110 and the DU 1130; each of the CU 1110, the DU 1130, and the RU 1140; the DU 1130; both the DU 1130 and the RU 1140; or the RU 1140. The CU 1110 may include at least one CU processor (or processing circuitry) 1112. The CU processor(s) (or processing circuitry) 1112 may include on-chip memory (or memory circuitry) 1112′. In some aspects, the CU 1110 may further include additional memory modules 1114 and a communications interface 1118. The CU 1110 communicates with the DU 1130 through a midhaul link, such as an F1 interface. The DU 1130 may include at least one DU processor (or processing circuitry) 1132. The DU processor(s) (or processing circuitry) 1132 may include on-chip memory (or memory circuitry) 1132′. In some aspects, the DU 1130 may further include additional memory modules 1134 and a communications interface 1138. The DU 1130 communicates with the RU 1140 through a fronthaul link. The RU 1140 may include at least one RU processor (or processing circuitry) 1142. The RU processor(s) (or processing circuitry) 1142 may include on-chip memory (or memory circuitry) 1142′. In some aspects, the RU 1140 may further include additional memory modules 1144, one or more transceivers 1146, antennas 1180, and a communications interface 1148. The RU 1140 communicates with the UE 104. The on-chip memory (or memory circuitry) 1112′, 1132′, 1142′ and the additional memory modules 1114, 1134, 1144 may each be considered a computer-readable medium/memory (or memory circuitry). Each computer-readable medium/memory (or memory circuitry) may be non-transitory. Each of the processors (or processing circuitry) 1112, 1132, 1142 is responsible for general processing, including the execution of software stored on the computer-readable medium/memory (or memory circuitry). The software, when executed by the corresponding processor(s) (or processing circuitry) causes the processor(s) (or processing circuitry) to perform the various functions described supra. The computer-readable medium/memory (or memory circuitry) may also be used for storing data that is manipulated by the processor(s) (or processing circuitry) when executing software.

As discussed supra, the component 199 may be configured to transmit or receive a first transmission of a physical channel, where the physical channel includes one of a PDSCH or a PUSCH, where the first transmission of the physical channel includes a PTRS having the pattern; and transmit or receive a subsequent retransmission of the physical channel, where the subsequent retransmission of the physical channel includes a PTRS having the pattern, where the pattern is independent of whether the first transmission was an initial transmission or a prior retransmission. The component 199 may be further configured to perform any of the aspects described in connection with the flowchart in FIG. 9, and/or performed by the base station 704 in FIG. 7. The component 199 may be within one or more processors (or processing circuitry) of one or more of the CU 1110, DU 1130, and the RU 1140. The component 199 may be one or more hardware components specifically configured to carry out the stated processes/algorithm, implemented by one or more processors configured to perform the stated processes/algorithm, stored within a computer-readable medium for implementation by one or more processors, or some combination thereof. When multiple processors are implemented, the multiple processors may perform the stated processes/algorithm individually or in combination. The network entity 1102 may include a variety of components configured for various functions. In one configuration, the network entity 1102 includes means for transmitting or receiving a first transmission of a physical channel, where the physical channel includes one of a PDSCH or a PUSCH, where the first transmission of the physical channel includes a PTRS having the pattern, and means for transmitting or receiving a subsequent retransmission of the physical channel, where the subsequent retransmission of the physical channel includes a PTRS having the pattern, where the pattern is independent of whether the first transmission was an initial transmission or a prior retransmission. The network entity 1102 may further include means for performing any of the aspects described in connection with the flowchart in FIG. 9, and/or aspects performed by the base station 704 in FIG. 7. The means may be the component 199 of the network entity 1102 configured to perform the functions recited by the means. As described supra, the network entity 1102 may include the TX processor 316, the RX processor 370, and the controller/processor 375. As such, in one configuration, the means may be the TX processor 316, the RX processor 370, and/or the controller/processor 375 configured to perform the functions recited by the means.

This disclosure provides a method for wireless communication at a UE. The method may include transmitting or receiving a first transmission of a physical channel, where the physical channel includes one of a PDSCH or a PUSCH; and transmitting or receiving a subsequent retransmission of the physical channel, where the subsequent retransmission of the physical channel includes a PTRS having a pattern that is independent of whether the first transmission was an initial transmission or a prior retransmission. By using a fixed PTRS setting, which may be determined based on a fixed MCS or a fixed codeword, for the subsequent retransmissions of signals on the PDSCH or PUSCH, the methods address and mitigate the discrepancies and inconsistencies resulting from missed DCI about initial transmission statuses, thereby enhancing the reliability and efficiency of wireless communication. Additionally, by consistently using a fixed MCS or a fixed codeword for PTRS in retransmissions, the methods simplify the decision-making process for PTRS settings in retransmissions, thereby lowering the computational burden on the network or UE.

It is understood that the specific order or hierarchy of blocks in the processes/flowcharts disclosed is an illustration of example approaches. Based upon design preferences, it is understood that the specific order or hierarchy of blocks in the processes/flowcharts may be rearranged. Further, some blocks may be combined or omitted. The accompanying method claims present elements of the various blocks in a sample order, and are not limited to the specific order or hierarchy presented.

The previous description is provided to enable any person skilled in the art to practice the various aspects described herein. Various modifications to these aspects will be readily apparent to those skilled in the art, and the generic principles defined herein may be applied to other aspects. Thus, the claims are not limited to the aspects described herein, but are to be accorded the full scope consistent with the language claims. Reference to an element in the singular does not mean “one and only one” unless specifically so stated, but rather “one or more.” Terms such as “if,” “when,” and “while” do not imply an immediate temporal relationship or reaction. That is, these phrases, e.g., “when,” do not imply an immediate action in response to or during the occurrence of an action, but simply imply that if a condition is met then an action will occur, but without requiring a specific or immediate time constraint for the action to occur. The word “exemplary” is used herein to mean “serving as an example, instance, or illustration.” Any aspect described herein as “exemplary” is not necessarily to be construed as preferred or advantageous over other aspects. Unless specifically stated otherwise, the term “some” refers to one or more. Combinations such as “at least one of A, B, or C,” “one or more of A, B, or C,” “at least one of A, B, and C,” “one or more of A, B, and C,” and “A, B, C, or any combination thereof” include any combination of A, B, and/or C, and may include multiples of A, multiples of B, or multiples of C. Specifically, combinations such as “at least one of A, B, or C,” “one or more of A, B, or C,” “at least one of A, B, and C,” “one or more of A, B, and C,” and “A, B, C, or any combination thereof” may be A only, B only, C only, A and B, A and C, B and C, or A and B and C, where any such combinations may contain one or more member or members of A, B, or C. Sets should be interpreted as a set of elements where the elements number one or more. Accordingly, for a set of X, X would include one or more elements. When at least one processor is configured to perform a set of functions, the at least one processor, individually or in any combination, is configured to perform the set of functions. Accordingly, each processor of the at least one processor may be configured to perform a particular subset of the set of functions, where the subset is the full set, a proper subset of the set, or an empty subset of the set. A processor may be referred to as processor circuitry. A memory/memory module may be referred to as memory circuitry. If a first apparatus receives data from or transmits data to a second apparatus, the data may be received/transmitted directly between the first and second apparatuses, or indirectly between the first and second apparatuses through a set of apparatuses. A device configured to “output” data or “provide” data, such as a transmission, signal, or message, may transmit the data, for example with a transceiver, or may send the data to a device that transmits the data. A device configured to “obtain” data, such as a transmission, signal, or message, may receive, for example with a transceiver, or may obtain the data from a device that receives the data. Information stored in a memory includes instructions and/or data. All structural and functional equivalents to the elements of the various aspects described throughout this disclosure that are known or later come to be known to those of ordinary skill in the art are expressly incorporated herein by reference and are encompassed by the claims. Moreover, nothing disclosed herein is dedicated to the public regardless of whether such disclosure is explicitly recited in the claims. The words “module,” “mechanism,” “element,” “device,” and the like may not be a substitute for the word “means.” As such, no claim element is to be construed as a means plus function unless the element is expressly recited using the phrase “means for.”

As used herein, the phrase “based on” shall not be construed as a reference to a closed set of information, one or more conditions, one or more factors, or the like. In other words, the phrase “based on A” (where “A” may be information, a condition, a factor, or the like) shall be construed as “based at least on A” unless specifically recited differently.

The following aspects are illustrative only and may be combined with other aspects or teachings described herein, without limitation.

Aspect 1 is a method of wireless communication at a UE. The method includes transmitting or receiving a first transmission of a physical channel, wherein the physical channel includes one of a physical downlink shared channel (PDSCH) or a physical uplink shared channel (PUSCH); and transmitting or receiving a subsequent retransmission of the physical channel, wherein the subsequent retransmission of the physical channel comprises a phase tracking reference signal (PTRS) having a pattern independent of whether the first transmission was an initial transmission or a prior retransmission.

Aspect 2 is the method of aspect 1, where transmitting or receiving the first transmission of the physical channel includes transmitting, to a network entity, the first transmission of the PUSCH, and where transmitting or receiving the subsequent retransmission of the physical channel includes transmitting, to the network entity, the subsequent retransmission of the PUSCH.

Aspect 3 is the method of aspect 1, where transmitting or receiving the first transmission of the physical channel includes receiving, from a network entity, the first transmission of the PDSCH, and where transmitting or receiving the subsequent retransmission of the physical channel includes receiving, from the network entity, the subsequent retransmission of the PDSCH.

Aspect 4 is the method of any of aspects 1 to 3, wherein the first transmission of the physical channel comprises the PTRS having the pattern.

Aspect 5 is the method of any of aspects 1 to 4, where the method further includes receiving, from a network entity, downlink control information (DCI) comprising a new data indicator (NDI), wherein the subsequent retransmission of the physical channel is based on the NDI.

Aspect 6 is the method of any of aspects 1 to 5, wherein the pattern is based on a configured pattern.

Aspect 7 is the method of any of aspects 1 to 5, where the method further includes receiving, from a network entity, a pattern configuration indicative of the pattern for the PTRS.

Aspect 8 is the method of any of aspects 1 to 5, where the method further includes obtaining a modulation and coding scheme (MCS) for the subsequent retransmission of the physical channel; and determining, based on the MCS, the pattern of the PTRS.

Aspect 9 is the method of aspect 8, where obtaining the MCS includes receiving an MCS configuration indicating the MCS, or obtaining the MCS based on a configured MCS.

Aspect 10 is the method of any of aspects 1 to 3, wherein the subsequent retransmission of the physical channel includes multiple codewords, and wherein the method further includes determining, based on a fixed codeword of the multiple codewords, a modulation and coding scheme (MCS) for the subsequent retransmission; and determining, based on the MCS, the pattern for the PTRS.

Aspect 11 is the method of aspect 10, wherein the fixed codeword is based on a configured codeword.

Aspect 12 is the method of aspect 10, where the method further includes receiving, from a network entity, a codeword configuration indicating the fixed codeword.

Aspect 13 is the method of aspect 10, wherein the PTRS in the first transmission of the physical channel is based on the fixed codeword.

Aspect 14 is an apparatus for wireless communication at a UE, comprising: a processing system that includes processor circuitry and memory circuitry that stores code and is coupled with the processor circuitry, the processing system configured to cause the UE to perform the method of one or more of aspects 1-13.

Aspect 15 is an apparatus for wireless communication at a UE, comprising: at least one memory; and at least one processor coupled to the at least one memory and, where the at least one processor, individually or in any combination, is configured to perform the method of any of aspects 1-13.

Aspect 16 is the apparatus for wireless communication at a UE, comprising means for performing each step in the method of any of aspects 1-13.

Aspect 17 is an apparatus of any of aspects 14-16, further comprising a transceiver configured to receive or to transmit in association with the method of any of aspects 1-13.

Aspect 18 is a computer-readable medium (e.g., a non-transitory computer-readable medium) storing computer executable code at a UE, the code when executed by at least one processor causes the at least one processor to, individually or in any combination, perform the method of any of aspects 1-13.

Aspect 19 is a method of wireless communication at a network entity. The method includes transmitting or receiving a first transmission of a physical channel, wherein the physical channel includes one of a physical downlink shared channel (PDSCH) or a physical uplink shared channel (PUSCH), wherein the first transmission of the physical channel comprises a phase tracking reference signal (PTRS) having a pattern; and transmitting or receiving a subsequent retransmission of the physical channel, wherein the subsequent retransmission of the physical channel comprises a PTRS having the pattern, wherein the pattern is independent of whether the first transmission was an initial transmission or a prior retransmission.

Aspect 20 is the method of aspect 19, where the method further includes transmitting, to a user equipment (UE), downlink control information (DCI) comprising a new data indicator (NDI), wherein the subsequent retransmission of the physical channel is based on the NDI.

Aspect 21 is the method of any of aspects 19 to 20, where the method further includes transmitting, to a user equipment (UE), a pattern configuration indicative of the pattern for the PTRS.

Aspect 22 is the method of any of aspects 19 to 21, wherein the pattern of the PTRS is based on a modulation and coding scheme (MCS) for the subsequent retransmission of the physical channel.

Aspect 23 is the method of aspect 19, wherein the subsequent retransmission of the physical channel includes multiple codewords, and wherein the pattern for the PTRS is based on a modulation and coding scheme (MCS) associated with a fixed codeword of the multiple codewords.

Aspect 24 is the method aspect 23, wherein the method further includes transmitting, to a user equipment (UE), a codeword configuration indicating the fixed codeword.

Aspect 25 is an apparatus for wireless communication at a network entity, comprising: a processing system that includes processor circuitry and memory circuitry that stores code and is coupled with the processor circuitry, the processing system configured to cause the network entity to perform the method of one or more of aspects 19-24.

Aspect 26 is an apparatus for wireless communication at a network entity, comprising: at least one memory; and at least one processor coupled to the at least one memory and, where the at least one processor, individually or in any combination, is configured to perform the method of any of aspects 19-24.

Aspect 27 is the apparatus for wireless communication at a network entity, comprising means for performing each step in the method of any of aspects 19-24.

Aspect 28 is an apparatus of any of aspects 25-27, further comprising a transceiver configured to receive or to transmit in association with the method of any of aspects 19-24.

Aspect 29 is a computer-readable medium (e.g., a non-transitory computer-readable medium) storing computer executable code at a network entity, the code when executed by at least one processor causes the at least one processor to, individually or in any combination, perform the method of any of aspects 19-24.

What is claimed is:

1. An apparatus for wireless communication at a user equipment (UE), comprising:
at least one memory; and
at least one processor coupled to the at least one memory and, based at least in part on information stored in the at least one memory, the at least one processor, individually or in any combination, is configured to cause the UE to:
transmit or receive a first transmission of a physical channel, wherein the physical channel includes one of a physical downlink shared channel (PDSCH) or a physical uplink shared channel (PUSCH); and
transmit or receive a subsequent retransmission of the physical channel, wherein the subsequent retransmission of the physical channel comprises a phase tracking reference signal (PTRS) having a pattern that is independent of whether the first transmission was an initial transmission or a prior retransmission.

2. The apparatus of claim 1, further comprising a transceiver coupled to the at least one processor, wherein to transmit or receive the first transmission of the physical channel, the at least one processor, individually or in any combination, is configured to cause the UE to transmit or receive the first transmission of the physical channel via the transceiver, and wherein to transmit or receive the first transmission of the physical channel, the at least one processor, individually or in any combination, is configured to cause the UE to:
transmit, to a network entity, the first transmission of the PUSCH, and wherein to transmit or receive the subsequent retransmission of the physical channel, the at least one processor, individually or in any combination, is configured to cause the UE to:
transmit, to the network entity, the subsequent retransmission of the PUSCH.

3. The apparatus of claim 1, wherein to transmit or receive the first transmission of the physical channel, the at least one processor, individually or in any combination, is configured to cause the UE to:
receive, from a network entity, the first transmission of the PDSCH, and wherein to transmit or receive the subsequent retransmission of the physical channel, the at least one processor, individually or in any combination, is configured to cause the UE to:
receive, from the network entity, the subsequent retransmission of the PDSCH.

4. The apparatus of claim 1, wherein the first transmission of the physical channel comprises the PTRS having the pattern.

5. The apparatus of claim 1, wherein the at least one processor, individually or in any combination, is further configured to cause the UE to:
receive, from a network entity, downlink control information (DCI) comprising a new data indicator (NDI), wherein the subsequent retransmission of the physical channel is based on the NDI.

6. The apparatus of claim 1, wherein the pattern is based on a configured pattern.

7. The apparatus of claim 1, wherein the at least one processor, individually or in any combination, is further configured to cause the UE to:
receive, from a network entity, a pattern configuration indicative of the pattern for the PTRS.

8. The apparatus of claim 1, wherein the at least one processor, individually or in any combination, is further configured to cause the UE to:
obtain a modulation and coding scheme (MCS) for the subsequent retransmission of the physical channel; and
determine, based on the MCS, the pattern of the PTRS.

9. The apparatus of claim 8, wherein to obtain the MCS, the at least one processor, individually or in any combination, is configured to cause the UE to:
receive an MCS configuration indicating the MCS, or
obtain the MCS based on a configured MCS.

10. The apparatus of claim 1, wherein the subsequent retransmission of the physical channel includes multiple codewords, and wherein the at least one processor, individually or in any combination, is further configured to cause the UE to:
determine, based on a fixed codeword of the multiple codewords, a modulation and coding scheme (MCS) for the subsequent retransmission; and
determine, based on the MCS, the pattern for the PTRS.

11. The apparatus of claim 10, wherein the fixed codeword is based on a configured codeword.

12. The apparatus of claim 10, wherein the at least one processor, individually or in any combination, is further configured to cause the UE to:
receive, from a network entity, a codeword configuration indicating the fixed codeword.

13. The apparatus of claim 10, wherein the PTRS in the first transmission of the physical channel is based on the fixed codeword.

14. An apparatus for wireless communication at a network entity, comprising:
at least one memory; and
at least one processor coupled to the at least one memory and, based at least in part on information stored in the at least one memory, the at least one processor, individually or in any combination, is configured to cause the network entity to:
transmit or receive a first transmission of a physical channel, wherein the physical channel includes one of a physical downlink shared channel (PDSCH) or a physical uplink shared channel (PUSCH), wherein the first transmission of the physical channel comprises a phase tracking reference signal (PTRS) having a pattern; and
transmit or receive a subsequent retransmission of the physical channel, wherein the subsequent retransmission of the physical channel comprises a PTRS having the pattern, wherein the pattern is independent of whether the first transmission was an initial transmission or a prior retransmission.

15. The apparatus of claim 14, further comprising a transceiver coupled to the at least one processor, wherein to transmit or receive the first transmission of the physical channel, the at least one processor, individually or in any combination, is configured to cause the network entity to transmit or receive the first transmission of the physical channel via the transceiver, and wherein the at least one processor, individually or in any combination, is further configured to cause the network entity to:
transmit, to a user equipment (UE), downlink control information (DCI) comprising a new data indicator (NDI), wherein the subsequent retransmission of the physical channel is based on the NDI.

16. The apparatus of claim 14, wherein the at least one processor, individually or in any combination, is further configured to cause the network entity to:
transmit, to a user equipment (UE), a pattern configuration indicative of the pattern for the PTRS.

17. The apparatus of claim 14, wherein the pattern of the PTRS is based on a fixed modulation and coding scheme (MCS) for the subsequent retransmission of the physical channel.

18. The apparatus of claim 14, wherein the subsequent retransmission of the physical channel includes multiple codewords, and wherein the pattern for the PTRS is based on a fixed modulation and coding scheme (MCS) associated with a fixed codeword of the multiple codewords.

19. The apparatus of claim 18, wherein the at least one processor, individually or in any combination, is configured to cause the network entity to:
transmit, to a user equipment (UE), a codeword configuration indicating the fixed codeword.

20. A method of wireless communication at a user equipment (UE), comprising:
transmitting or receiving a first transmission of a physical channel, wherein the physical channel includes one of a physical downlink shared channel (PDSCH) or a physical uplink shared channel (PUSCH); and
transmitting or receiving a subsequent retransmission of the physical channel, wherein the subsequent retransmission of the physical channel comprises a phase tracking reference signal (PTRS) having a pattern that is independent of whether the first transmission was an initial transmission or a prior retransmission.
